(19) United States
(12) Patent Application Publication
(10) Pub. No.: US 2025/0360415 A1
(43) Pub. Date: Nov. 27, 2025

(54) VIRTUAL CHARACTER BATTLE METHOD AND APPARATUS, DEVICE, MEDIUM, AND PROGRAM PRODUCT

(71) Applicant: Tencent Technology (Shenzhen) Company Limited, Shenzhen (CN)

(72) Inventor: Lingyun LIN, Shenzhen (CN)

(21) Appl. No.: 19/297,923

(22) Filed: Aug. 12, 2025

Related U.S. Application Data
(63) Continuation of application No. PCT/CN2024/095473, filed on May 27, 2024.

(30) Foreign Application Priority Data
Aug. 1, 2023 (CN) 202310969952.3

(51) Int. Cl. A63F 13/58; A63F 13/52

(52) U.S. Cl. CPC A63F 13/58; A63F 13/52

(57) ABSTRACT

A virtual character battle method is performed by a computer device. The method includes: displaying a virtual scene including a first virtual character and a second virtual character that have a confrontation relationship and a virtual support character, and the second virtual character being configured for hindering automatic movement of the virtual support character in the virtual scene; in response to receiving a control operation performed on the first virtual character by a user of the computer device, displaying interaction between the first virtual character and the virtual support character when the first virtual character escorts the virtual support character; and in response to the virtual support character moving to a first position in the virtual scene, displaying a first battle result configured for indicating that the first virtual character wins a battle.

### CROSS-REFERENCE TO RELATED APPLICATIONS

This application is a continuation application of PCT Patent Application No. PCT/CN2024/095473, entitled “VIRTUAL CHARACTER PROCESSING METHOD AND APPARATUS, ELECTRONIC DEVICE, COMPUTER-READABLE STORAGE MEDIUM, AND COMPUTER PROGRAM PRODUCT” filed on May 27, 2024, which claims priority to Chinese Patent Application No. 202310969952.3, entitled “VIRTUAL CHARACTER BATTLE METHOD AND APPARATUS, DEVICE, MEDIUM, AND PROGRAM PRODUCT” filed on Aug. 1, 2023, both of which are incorporated herein by reference in their entirety.

### FIELD OF THE TECHNOLOGY

Embodiments of this application relate to the field of human-computer interaction, and in particular, to a virtual character battle method and apparatus, a device, a medium, and a program product.

### BACKGROUND OF THE DISCLOSURE

In competitive games, a player can control a virtual character to participate in a virtual battle. The virtual battle may be conducted in various manners. The player may control the virtual character to defeat a virtual character of an opponent to win the virtual battle, or complete a battle task required in the virtual battle to win the virtual battle.

In the related art, a manner of conducting a virtual battle is provided. In the virtual battle, a player needs to control a virtual character to escort a virtual object to a specified position, and a virtual character of an opponent needs to prevent the virtual character from moving the virtual object to the specified position. Generally, the player carries the virtual object to move, and the virtual character of the opponent may prevent movement of the virtual object by attacking the virtual character controlled by the player.

In the related art, the virtual object is only used as a fixed transported object moving with the virtual character, and the virtual object has small impact on the result of the virtual battle. In other words, utilization of the virtual object is relatively low in the virtual battle, resulting in relatively low utilization of computer resources.

### SUMMARY

Embodiments of this application provide a virtual character battle method and apparatus, a device, a medium, and a program product, which can improve utilization of computer resources. Technical solutions are as follows.

According to an aspect, a virtual character battle method is performed by a computer device. The method includes:
displaying a virtual scene including a first virtual character and a second virtual character that have a confrontation relationship and a virtual support character, and the second virtual character being configured for hindering automatic movement of the virtual support character in the virtual scene;
in response to receiving a control operation performed on the first virtual character by a user of the computer device, displaying interaction between the first virtual character and the virtual support character when the first virtual character escorts the virtual support character; and
in response to the virtual support character moving to a first position in the virtual scene, displaying a first battle result configured for indicating that the first virtual character wins a battle.

According to another aspect, a computer device is provided. The computer device includes a processor and a memory. The memory has at least one instruction, at least one segment of program, a code set, or an instruction set stored therein. The at least one instruction, the at least one segment of program, the code set, or the instruction set is loaded and executed by the processor and causes the computer device to implement any virtual character battle method according to the following embodiments.

According to another aspect, a non-transitory computer-readable storage medium is provided. The storage medium has at least one instruction, at least one segment of program, a code set, or an instruction set stored therein. The at least one instruction, the at least one segment of program, the code set, or the instruction set is loaded and executed by a processor of a computer device and causes the computer device to implement the virtual character battle method according to any one of the foregoing embodiments.

The technical solutions provided in the embodiments of this application produce at least the following beneficial effects.

A virtual support character is displayed in a virtual scene in which a first virtual character battles against a second virtual character. The virtual support character automatically moves toward a first position in the virtual scene, and the first virtual character is a virtual character escorting the virtual support character, to defend against a process of the second virtual character hindering movement of the virtual support character. A control operation controlling the first virtual character to interact with the virtual support character is received, and the interaction between the first virtual character and the virtual support character is displayed. A battle result is further determined according to a position of the virtual support character. In the foregoing process, the battle result is determined according to whether the virtual support character with which the first virtual character interacts moves to the first position instead of completely depending on a fixed virtual object. The virtual support character is used as a character movable in the virtual scene, so that utilization of the virtual support character is relatively high. In addition, the virtual support character has relatively high impact on the battle result, avoiding a problem that there are few game interaction forms in which a virtual character moves a fixed virtual object, increasing fun of a game, and improving utilization of computer resources.

### BRIEF DESCRIPTION OF THE DRAWINGS

FIG. 1 is a structural block diagram of an electronic device according to an exemplary embodiment of this application.

FIG. 2 is a schematic diagram of a computer system according to an exemplary embodiment of this application.

FIG. 3 is a flowchart of a virtual character battle method according to an exemplary embodiment of this application.

FIG. 4 is a flowchart of a virtual character battle method according to another embodiment of this application.

FIG. 5 is a schematic diagram of a battle interface of a virtual battle according to an exemplary embodiment of this application.

FIG. 6 is a schematic diagram of a virtual robot according to an exemplary embodiment of this application.

FIG. 7 is a schematic diagram of an appearance design of a robot according to an exemplary embodiment of this application.

FIG. 8 is a schematic diagram of an operating rule of a robot according to an exemplary embodiment of this application.

FIG. 9 is a flowchart of a virtual character battle method according to still another exemplary embodiment of this application.

FIG. 10 is a schematic diagram of state switching according to an exemplary embodiment of this application.

FIG. 11 is a flowchart of a virtual character battle method according to yet another exemplary embodiment of this application.

FIG. 12 is a schematic diagram of an overall setting of an attack-defense mode according to an exemplary embodiment of this application.

FIG. 13 is an overall flowchart of an attack-defense mode game according to an exemplary embodiment of this application.

FIG. 14 is a flowchart of determining an attacking party in an extra round according to an exemplary embodiment of this application.

FIG. 15 is a structural block diagram of a virtual character battle apparatus according to an exemplary embodiment of this application.

FIG. 16 is a structural block diagram of a terminal according to an exemplary embodiment of this application.

### DESCRIPTION OF EMBODIMENTS

The embodiments of this application provide a virtual character battle method. A virtual support character fully participates in a whole battle of virtual characters, and a battle result is determined according to whether a virtual support character having a moving function moves to a first position instead of depending on a movement status of a fixed virtual object accompanying a first virtual character. In this way, utilization of the virtual support character is greatly improved, and an impact of the virtual support character having a movement effect on the battle result is improved, thereby improving utilization of computer resources.

A terminal in this application may be a desktop computer, a portable laptop computer, a mobile phone, a tablet computer, an ebook reader, a moving picture experts group audio layer III (MP3) player, a moving picture experts group audio layer IV (MP4) player, or the like. An application supporting a virtual scene, for example, an application supporting a three-dimensional virtual scene, is installed and run on the terminal. The application may be any one of a virtual reality application, a third-person shooting (TPS) game, a first-person shooting (FPS) game, and a multiplayer online battle arena (MOBA) game, a role-playing game, or a turn-based action game. In some embodiments, the application may be a standalone application, such as a standalone three-dimensional game program, or may be an online application.

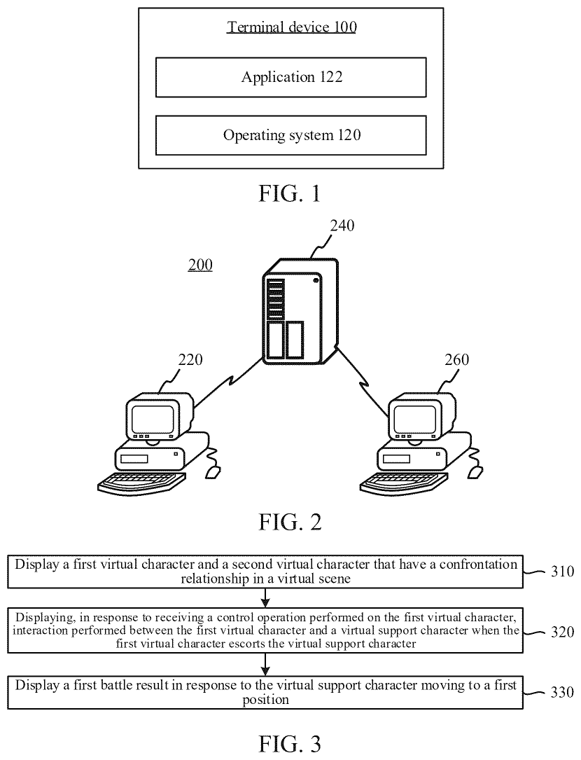

FIG. 1 is a structural block diagram of an electronic device according to an exemplary embodiment of this application. An electronic device 100 includes an operating system 120 and an application 122.

The operating system 120 is basic software provided for the application 122 to perform secure access to computer hardware.

The application 122 is an application supporting a virtual scene. In some embodiments, the application 122 is an application supporting a three-dimensional virtual scene. The application 122 may be any one of a virtual reality application, a TPS game, an FPS game, a MOBA game, a role-playing game, a turn-based action game, or the like. The application 122 may be a standalone application, such as a standalone three-dimensional game program, or may be an online application.

FIG. 2 is a structural block diagram of a computer system according to an exemplary embodiment of this application. The computer system 200 includes a first device 220, a server 240, and a second device 260.

An application supporting a virtual scene is installed and run on the first device 220. The application may be any one of a virtual reality application, a TPS game, an FPS game, a MOBA game, a role-playing game, a turn-based action game, or the like. The first device 220 is a device used by a first user. The first user uses the first device 220 to control a first virtual character in a virtual scene to perform an activity. The activity includes, but is not limited to, at least one of body posture adjustment, crawling, walking, running, riding, jumping, driving, picking up, shooting, attacking, or throwing. For example, the first virtual character is a first virtual person, such as a simulated person character or a cartoon person character.

The first device 220 is connected to the server 240 via a wireless network or a wired network.

The server 240 includes at least one type of one server, a plurality of servers, a cloud computing platform, or a virtualization center. The server 240 is configured to provide a backend service for an application supporting a three-dimensional virtual scene. In some embodiments, the server 240 is responsible for primary computing work, and the first device 220 and the second device 260 are responsible for secondary computing work; or the server 240 is responsible for secondary computing work, and the first device 220 and the second device 260 are responsible for primary computing work; or the server 240, the first device 220, and the second device 260 perform collaborative computing by using a distributed computing architecture.

An application supporting a virtual scene is installed and run on the second device 260. The application may be any one of a virtual reality application, a TPS game, an FPS game, a MOBA game, a role-playing game, a turn-based action game, or the like. The second device 260 is a device used by a second user. The second user uses the second device 260 to control a second virtual character in a virtual scene to perform an activity. The activity includes, but is not limited to, at least one of body posture adjustment, crawling, walking, running, riding, jumping, driving, picking up, shooting, attacking, or throwing. For example, the second virtual character is a second virtual person, such as a simulated person character or a cartoon person character.

In some embodiments, the first virtual character and the second virtual character are in a same virtual scene. In some embodiments, the first virtual character and the second virtual character may belong to a same team, belong to a same organization, have a friend relationship, or have a temporary communication permission. In some embodiments, the first virtual character and the second virtual character may alternatively belong to different teams, different organizations, or two opposing groups.

In some embodiments, the applications installed on the first device 220 and the second device 260 are the same, or the applications installed on the two devices are applications of the same type on different control system platforms. The first device 220 may be one of a plurality of devices, and the second device 260 may be one of a plurality of devices. This embodiment is described only by using the first device 220 and the second device 260 as an example. The first device 220 and the second device 260 are of the same device type or of different device types. The device type includes at least one of a game console, a desktop computer, a smartphone, a tablet computer, an ebook reader, an MP3 player, an MP4 player, or a laptop portable computer. The following embodiments are described by using an example in which the device is a desktop computer.

A person skilled in the art may learn that there may be more or fewer devices. For example, there may be only one device, or there may be dozens or hundreds of devices, or there may be more devices. The quantity of devices and the device type are not limited in embodiments of this application. The server 240 may be an independent physical server, or may be a server cluster formed by a plurality of physical servers or a distributed system, or may be a cloud server providing basic cloud computing services such as a cloud service, a cloud database, cloud computing, a cloud function, cloud storage, a network service, cloud communication, a middleware service, a domain name service, a security service, a content delivery network (CDN), a big data platform, and an artificial intelligence platform. The cloud technology refers to a hosting technology that combines a series of resources such as hardware, software, and networks in a wide area network or a local area network to perform data calculation, storage, processing, and sharing. A general term for a network technology, an information technology, an integration technology, a management platform technology, and an application technology that are applied based on a cloud computing business model. The cloud technology can form a resource pool, which is used on demand and is flexible and convenient. In some embodiments, the method provided in the embodiments of this application may be applied in a cloud gaming scenario, so that calculation of data logic in a game process is completed through a cloud server, and a terminal is responsible for display of a game interface.

In some embodiments, the server 240 may alternatively be implemented as a node in a blockchain system.

In this application, before and during collection of user-related data, a prompt interface or a pop-up window can be displayed, or voice prompt information can be outputted. The prompt interface, the pop-up window, or the voice prompt information is configured for prompting the user that the user-related data is currently being collected. In this way, in this application, related operations of obtaining the user-related data start to be performed only after a confirmation operation performed by the user on the prompt interface or the pop-up window is obtained. Otherwise (that is, when no confirmation operation performed by the user on the prompt interface or the pop-up window is obtained), the related operations of obtaining the user-related data are ended, that is, the user-related data is not to be obtained. In other words, in this application, all collected user data are collected with the consent and authorization of users. The collection, use, and processing of relevant user data need to comply with the relevant laws, regulations, and standards.

With reference to the foregoing descriptions and a computer system, FIG. 3 is a flowchart of a virtual character battle method according to an embodiment of this application. An example in which the method is applied to a terminal is used for description. As shown in FIG. 3, the method includes the following operation 310 to operation 330.

Operation 310: Display a first virtual character and a second virtual character that have a confrontation relationship in a virtual scene.

In some embodiments, the first virtual character is a virtual character controlled by a first terminal, and the second virtual character is a virtual character controlled by a second terminal.

In some embodiments, an application supporting a virtual scene is respectively run on the first terminal and the second terminal. The application may be any one of a virtual reality application, a TPS game, an FPS game, a MOBA game, a role-playing game, a turn-based action game, or the like.

In some embodiments, a first account is logged in to the application run on the first terminal, and the first virtual character is a virtual character corresponding to the first account; and a second account is logged in to the application run on the second terminal, and the second virtual character is a virtual character corresponding to the second account. Exemplarily, a player A logs in to the first account in an FPS game run on the first terminal, and after the login, the player A can control the first virtual character by using the first terminal; and a player B logs in to the second account in the FPS game run on the second terminal, and after the login, the player B can control the second virtual character by using the second terminal.

In some embodiments, the first terminal is a current terminal (that is, a terminal that currently performs the virtual character battle method), and the second terminal is a terminal other than the current terminal.

In some embodiments, the virtual scene is a battle scene in a virtual battle.

In some embodiments, the virtual battle is a battle in which the first virtual character fights against the second virtual character.

In some embodiments, the virtual battle includes at least two camps, and the first virtual character and the second virtual character belong to different camps. Exemplarily, the virtual battle includes a first camp and a second camp, the first camp has a confrontation relationship with the second camp, the first virtual character belongs to the first camp, and the second virtual character belongs to the second camp.

In some embodiments, the first camp includes only the first virtual character, or the first camp includes a plurality of virtual characters, and the plurality of virtual characters include the first virtual character. In some embodiments, the second camp includes only the second virtual character, or the second camp includes a plurality of virtual characters, and the plurality of virtual characters include the second virtual character.

The virtual scene includes a virtual support character.

In some embodiments, the virtual support character is a character having a moving capability in a virtual scene. The virtual support character may be a virtual person, a virtual animal, a cartoon person, or the like, for example, a person, an animal, or a plant displayed in a virtual scene. This is not limited in this embodiment of this application. In some embodiments, when the virtual scene is implemented as a three-dimensional virtual scene, the virtual support character is a three-dimensional model created based on an animation skeleton technology. The virtual support character has a shape and volume in the three-dimensional virtual scene, and occupies a part of space in the three-dimensional virtual scene.

In some embodiments, the virtual support character is implemented as a virtual character controlled by a system, for example, a non-player character (NPC) or an artificial intelligence (AI) character. That is, the virtual support character is not a manually controlled character but a character that automatically performs activities.

Exemplarily, the AI character refers to a virtual character simulated by using an artificial intelligence technology, and the artificial intelligence technology endows the virtual character with a higher intelligent decision-making capability. In a game, a conventional NPC usually follows a fixed behavior mode, and lacks flexibility and vividness. However, the AI character can perform autonomous learning and adaptive decision through machine learning and a reinforcement learning algorithm. In other words, the AI character can make a more intelligent and personalized response according to a behavior and an environment change of a player, increasing challenge and sense of reality of a game. In some other embodiments, the virtual support character may alternatively be a virtual character controlled by a player (that is, by the player by using a terminal); or the virtual support character is a virtual character jointly controlled by a player and a system.

The virtual support character is configured for providing battle assistance for a virtual character.

To be specific, the virtual support character is configured for providing battle assistance for the first virtual character and the second virtual character in a virtual battle. The virtual battle is a battle in which the first virtual character fights against the second virtual battle. In some embodiments, the battle assistance refers to providing assistance for a specified virtual character (for example, the first virtual character or the second virtual character) in a virtual battle.

In some embodiments, a form of battle assistance includes at least one of the following forms.

### 1. The Virtual Support Character is Configured for Providing a Bonus Effect for a Virtual Character.

In some embodiments, the bonus effect refers to increasing or reducing an attribute value of a virtual character. The attribute value includes at least one of a health value, an energy value, an attack power, a defense value, an attack speed, a movement speed, or the like. This is not limited in this embodiment of this application.

Exemplarily, the virtual support character increases a health value of the first virtual character to provide battle assistance for the first virtual character; or the virtual support character reduces a health value of the second virtual character to provide battle assistance for the first virtual character.

In some embodiments, the bonus effect is a single bonus effect; or the bonus effect is a multiple bonus effect lasting for a period of time.

In some embodiments, the virtual battle has battle duration and preset battle duration. The battle duration refers to a time interval between a start moment of a virtual battle and a current moment. The preset battle duration refers to preset duration of a virtual battle, and represents preset expiration duration of a game battle.

Exemplarily, the battle duration accumulates as a game progresses. For example, at the beginning of a game, battle duration is relatively short, and as the game progresses, the battle duration becomes longer. If the preset duration remains unchanged, a difference between the battle duration and the preset battle duration gradually decreases from the beginning of the game to the preset battle duration.

In some embodiments, considering that the first virtual character is configured for escorting the virtual support character, a larger difference between the battle duration and the preset battle duration indicates that the first virtual character has more time to escort the virtual support character. Therefore, there is a higher probability that the first virtual character can successfully escort the virtual support character, which is more beneficial to winning of the first virtual character in a battle. A smaller difference between the battle duration and the preset battle duration indicates less time for the first virtual character to escort the virtual support character. Therefore, there is a lower probability that the first virtual character successfully escorts the virtual support character, which is less beneficial to winning of the first virtual character in a battle. Correspondingly, if the first virtual character loses a battle, it indicates that the second virtual character wins the battle. That is, a smaller difference between the battle duration and the preset battle duration indicates that it is more beneficial to winning of the second virtual character in a battle.

In some embodiments, the bonus effect refers to increasing or reducing preset duration.

Exemplarily, the virtual support character increases the preset duration to provide battle assistance for the first virtual character; or the virtual support character reduces the preset duration to provide battle assistance for the second virtual character.

### 2. The Virtual Support Character Assists a Virtual Character by Using a Virtual Skill or a Virtual Item.

In some embodiments, the virtual skill includes at least one of a virtual treatment skill, a virtual attack skill, a virtual defense skill, or the like; and the virtual item includes at least one of a virtual treatment item, a virtual attack item, a virtual defense item, or the like.

Exemplarily, the virtual support character may use the virtual treatment skill to recover a health value of the first virtual character, to provide battle assistance for the first virtual character; or the virtual support character may use the virtual attack item to attack the second virtual character, to provide battle assistance for the first virtual character.

3. The Virtual Support Character Assists a Virtual Character Through a Movement state.

In some embodiments, a battle mode of a virtual battle is an attack-defense mode. The first virtual character is an attacking party, and the second virtual character is a defending party.

In some embodiments, the first virtual character is an attacking party, and the first virtual character has a corresponding first battle win condition. The first battle win condition includes: a distance between a position of the virtual support character and a specified position being less than or equal to a preset distance.

In some embodiments, the specified position is a preset position in a virtual scene, that is, a movement destination position of the virtual support character, and the preset distance is a distance that is preset. Exemplarily, when the preset distance is 0, that is, the virtual support character moves to the specified position, the first virtual character wins a battle.

In some embodiments, the second virtual character is a defending party, and the second virtual character has a corresponding second battle win condition. The second battle win condition includes: a distance between a position of the virtual support character and a specified position is greater than a preset distance. Exemplarily, when the preset distance is 0, that is, the virtual support character does not move to the specified position, the second virtual character wins a battle.

In some embodiments, the virtual battle has corresponding battle duration. The battle duration refers to a time interval between a start moment of a virtual battle and a current moment.

The first battle win condition further includes: when the battle duration is less than preset duration, the distance between the position of the virtual support character and the specified position being less than or equal to a preset distance.

In some embodiments, when the battle duration is less than the preset duration, and the distance between the position of the virtual support character and the specified position is less than or equal to the preset distance, it is determined that the first virtual character wins a battle. Exemplarily, it is assumed that the preset duration is two minutes, when the preset distance is 0, if the virtual support character moves to the specified position within two minutes after the virtual battle starts, the first virtual character wins the battle.

The second battle win condition includes: when the battle duration reaches the preset duration, the distance between the position of the virtual support character and the specified position being greater than the preset distance.

In some embodiments, when the battle duration reaches the preset duration, and the distance between the position of the virtual support character and the specified position is greater than the preset distance, it is determined that the second virtual character wins the battle. Exemplarily, it is assumed that the preset duration is two minutes, when the preset distance is 0, if the virtual support character does not move to the specified position at the second minute after the virtual battle starts, the second virtual character wins the battle.

In the foregoing embodiment, the position of the virtual support character affects a result of a virtual battle. In this case, the position of the virtual support character may alternatively be changed by changing a movement state, to provide battle assistance for a virtual character.

The virtual support character automatically moves toward the first position in the virtual scene.

Exemplarily, the first position is a position corresponding to the first virtual character. A game objective of the player is to control the first virtual character to interact with the virtual support character, to escort the automatically moving virtual support character to move to the first position corresponding to the first virtual character in a targeted manner.

The first virtual character is configured for escorting the virtual support character, and the second virtual character is configured for hindering automatic movement of the virtual support character.

Exemplarily, in a process in which the first virtual character protects the virtual support character to move to the first position, the second virtual character is used as a virtual character in a virtual camp different from a virtual camp of the first virtual character, and needs to prevent a process in which the virtual support character moves toward the first position.

In some embodiments, a smaller distance between the position of the virtual support character and the specified position (where the specified position is a preset location in the virtual scene) is more beneficial to winning a battle of the first virtual character.

In some embodiments, the virtual support character moves in a direction close to the specified position, to reduce the distance between the position of the virtual support character and the specified position; or the virtual support character is teleported from a current position to a first teleportation position, and a distance between the current position and the specified position is greater than a distance between the first teleportation position and the specified position.

In some embodiments, a larger distance between the position of the virtual support character and the specified position is more beneficial to winning a battle of the second virtual character.

In some embodiments, the virtual support character moves in a direction away from the specified position, to increase the distance between the virtual support character and the specified position; or the virtual support character is teleported from a current position to a second teleportation position, and a distance between the current position and the specified position is less than a distance between the second teleportation position and the specified position.

The above descriptions of the forms of battle assistance are merely examples. Forms and a quantity of battle assistance are not limited in the embodiments of this application.

Operation 320: Display, in response to receiving a control operation performed on the first virtual character, interaction performed between the first virtual character and the virtual support character when the first virtual character escorts the virtual support character.

In some embodiments, the first terminal receives the control operation performed on the first virtual character, and the control operation is an operation triggered by a player on the first terminal. Exemplarily, the control operation is an operation triggered by the player by using a touchscreen, a mouse, a keyboard, or another external device of the first terminal; or the control operation is an operation triggered by the player directly on a screen of the first terminal.

In some other embodiments, the control operation is an operation triggered automatically by a system.

The control operation is configured for controlling the first virtual character to interact with the virtual support character.

Exemplarily, the controlling the first virtual character to interact with the virtual support character includes: controlling the first virtual character to carry the virtual support character, controlling the first virtual character to approach the virtual support character, controlling the first virtual character to interact (for example, chat) with the virtual support character, controlling the first virtual character to protect the virtual support character (for example, add an attribute value of the virtual support character by using a virtual item or a virtual skill), controlling the first virtual character to complete a task released by the virtual support character, or the like. This is not limited in this embodiment of this application.

In some embodiments, in response to receiving a control operation controlling the first virtual character to move to a preset character range corresponding to the virtual support character, the interaction performed between the first virtual character and the virtual support character when the first virtual character escorts the virtual support character is displayed.

Exemplarily, the preset character range corresponding to the virtual support character is configured for representing a specific area range around the virtual support character. The player may control the first virtual character to move to a peripheral area corresponding to the virtual support character, to implement the control operation performed on the first virtual character. In addition, under the control operation, the interaction performed between the first virtual character and the virtual support character when the first virtual character escorts the virtual support character is displayed, for example, the first virtual character and the virtual support character are kept within a specific distance.

In some embodiments, in response to receiving a control operation controlling the first virtual character to interact with the virtual support character, the interaction performed between the first virtual character and the virtual support character when the first virtual character escorts the virtual support character is displayed.

Exemplarily, an interaction manner is implemented in a form of chat, touch (for example, handshake or stroke), or the like. The first virtual character is controlled to perform an interaction process with the virtual support character, for example, the first virtual character is controlled to chat with the virtual support character in a virtual scene, or the first virtual character is controlled to touch the virtual support character, to implement the control operation performed on the first virtual character. In addition, under the control operation, the interaction performed between the first virtual character and the virtual support character when the first virtual character escorts the virtual support character is displayed, for example, the first virtual character and the virtual support character walk hand in hand.

In some embodiments, in response to receiving a control operation controlling the first virtual character to protect the virtual support character from being attacked by the second virtual character, the interaction performed between the first virtual character and the virtual support character when the first virtual character escorts the virtual support character is displayed.

Exemplarily, the first virtual character may protect the virtual support character in at least one manner of a plurality of game skills such as releasing a defense skill and releasing an attack skill, thereby performing the control operation or the like on the first virtual character. Under the control operation, the virtual support character may use the first position as a target to perform a moving process. In addition, under the control operation, the interaction performed between the first virtual character and the virtual support character when the first virtual character escorts the virtual support character is displayed, for example, the first virtual character uses a virtual shield to defend against a virtual attack of the second virtual character on the virtual support character.

Exemplarily, different from a fixed virtual item interacting with the first virtual character, in this embodiment of this application, the virtual support character interacting with the first virtual character has a moving function in the virtual scene. In other words, the virtual support character may move in the virtual scene to change a position of the virtual support character. When the virtual support character moves in the virtual scene, the first virtual character may interact with the virtual support character, to maintain movement of the virtual support character, so that the virtual support character may perform a targeted movement process in a direction in which the first virtual character expects to move.

The foregoing content describes content of receiving different forms of control operations. Under a condition that a game objective of the first virtual character is to interact with the virtual support character to move to the first position, the first virtual character may be controlled to interact with the virtual support character in the virtual scene, to keep, through the control operation, the virtual support character moving in the virtual scene, so that the first virtual character enables, through the interaction, the virtual support character to move toward a specified position, thereby achieving the game objective. With help of the virtual support character having a movement effect, a limitation of a conventional fixed virtual item mode is overcome, enriching gameplay and improving fun of a game, and improving human-computer interaction efficiency.

In some embodiments, a representation of the virtual support character may be changed to some extent based on the control operation performed on the first virtual character. For example, when the first virtual character is controlled to move nearby the virtual support character, the virtual support character forms a gain effect on the first virtual character; or when the first virtual character is controlled to complete a task released by the virtual support character, the virtual support character forms a gain effect on the first virtual character.

In some embodiments, a representation of the virtual support character may alternatively be changed to some extent based on a change of the virtual support character in the virtual scene. For example, when the virtual support character continuously and automatically walks in the virtual scene, an attribute value of the virtual support character is consumed; or when the virtual support character encounters an obstacle in the virtual scene, the virtual support character needs to detour.

In an exemplary embodiment, when the virtual support character satisfies a first assistance condition, a first assistance animation of the virtual support character providing battle assistance for the first virtual character is displayed.

In some embodiments, the first assistance condition includes at least one of: an attribute value of a virtual support character being greater than a preset attribute value, the first virtual character existing within a preset character range of the virtual support character, or the like.

In some embodiments, when an attribute value of the virtual support character is greater than a preset attribute value, the first assistance animation of the virtual support character providing battle assistance for the first virtual character is displayed.

The attribute value includes at least one of a health value, an energy value, an attack power, a defense value, an attack speed, a movement speed, or the like. This is not limited in this embodiment of this application.

Exemplarily, if a health value of the virtual support character is greater than a preset health value, it is determined that the virtual support character satisfies the first assistance condition. In this case, the first assistance animation of the virtual support character providing battle assistance for the first virtual character is displayed.

In some other embodiments, when the first virtual character is within the preset character range of the virtual support character, the first assistance animation of the virtual support character providing battle assistance for the first virtual character is displayed.

Exemplarily, if the first virtual character moves into the preset character range of the virtual support character, it is determined that the virtual support character satisfies the first assistance condition. In this case, the first assistance animation of the virtual support character providing battle assistance for the first virtual character is displayed.

In some other embodiments, when the attribute value of the virtual support character is greater than the preset attribute value, and the first virtual character is within the preset character range of the virtual support character, the first assistance animation of the virtual support character providing battle assistance for the first virtual character is displayed.

Exemplarily, if a health value of the virtual support character is greater than a preset health value, and the first virtual character moves into the preset character range of the virtual support character, it is determined that the virtual support character satisfies the first assistance condition. In this case, the first assistance animation of the virtual support character providing battle assistance for the first virtual character is displayed.

In some embodiments, when the attribute value of the virtual support character is greater than the preset attribute value, and the first virtual character is within the preset character range of the virtual support character, in response to duration for which the first virtual character is within the preset character range of the virtual support character reaching first preset duration, the first assistance animation of the virtual support character providing battle assistance for the first virtual character is displayed.

Exemplarily, if a health value of the virtual support character is greater than a preset health value, and the first virtual character moves into the preset character range of the virtual support character, when duration for which the first virtual character stays within the preset character range reaches first preset duration, it is determined that the virtual support character satisfies the first assistance condition. In this case, the first assistance animation of the virtual support character providing battle assistance for the first virtual character is displayed.

In some embodiments, battle assistance provided by the virtual support character for the first virtual character includes at least one of: providing a bonus effect for the first virtual character, assisting the first virtual character by using a virtual skill or a virtual item, assisting the first virtual character by changing a corresponding movement state, or the like.

In some embodiments, a smaller distance between the position of the virtual support character and the specified position is more beneficial to winning a battle of the first virtual character.

In some embodiments, when the virtual support character satisfies the first assistance condition, a movement animation of the virtual support character moving toward the specified position is displayed, and the movement animation is used as the first assistance animation.

Exemplarily, if the virtual support character satisfies the first assistance condition, the virtual support character moves toward the specified position to reduce the distance between the position of the virtual support character and the specified position, to assist the first virtual character to win the battle.

In some other embodiments, the virtual support character may provide a speed bonus to the first virtual character to assist the first virtual character.

In some embodiments, when the virtual support character satisfies the first assistance condition, a speed bonus animation of the first virtual character is displayed, and the speed bonus animation is used as the first assistance animation.

Exemplarily, if the virtual support character satisfies the first assistance condition, the first virtual character obtains a speed bonus. The speed bonus is merely configured for increasing a moving speed of the first virtual character, so that the first virtual character can participate in a virtual battle at a higher moving speed. In some embodiments, when the first virtual character carries the virtual support character, that the moving speed of the first virtual character is increased means that a moving speed of the virtual support character is increased.

In some embodiments, the speed bonus animation may be implemented as displaying a speed bonus sign, and the speed bonus sign is configured for presenting that the moving speed of the first virtual character is increased.

In some embodiments, the speed bonus animation has corresponding preset speed bonus duration, and in response to that playback duration of the speed bonus animation reaches the preset speed bonus duration, playing of the speed bonus animation is stopped. Exemplarily, duration for which the virtual support character provides the speed bonus for the first virtual character is limited. When a duration limit is reached, the virtual support character stops providing the speed bonus for the first virtual character.

In some embodiments, when the virtual support character satisfies the first assistance condition, a movement animation of the virtual support character moving toward the specified position and a speed bonus animation of the first virtual character are displayed, and the movement animation and the speed bonus animation are used as the first assistance animation. Exemplarily, if the virtual support character satisfies the first assistance condition, the virtual support character moves toward the specified position, and the virtual support character provides a speed bonus for the first virtual character.

In some embodiments, when the attribute value of the virtual support character is greater than the preset attribute value, and the first virtual character is outside the preset character range of the virtual support character, a movement animation of the virtual support character moving toward the specified position at a first speed is displayed. When the attribute value of the virtual support character is greater than the preset attribute value, and the first virtual character is within the preset character range of the virtual support character, a movement animation of the virtual support character moving toward the specified position at a second speed is displayed. The first speed is lower than the second speed.

Exemplarily, if a health value of the virtual support character is greater than a preset health value, and the first virtual character does not move to the preset character range of the virtual support character, the virtual support character moves toward the specified position slowly; or if the first virtual character moves into the preset character range of the virtual support character, the virtual support character accelerates and moves toward the specified position.

In some embodiments, the first virtual character is a virtual character of a first camp, the first camp further includes other virtual characters, and the second speed is associated with a virtual character of the first camp included in the preset character range of the virtual support character.

In some embodiments, the second speed is positively correlated to a character quantity of virtual characters of the first camp included in the preset character range of the virtual support character. Exemplarily, if there is one virtual character of the first camp within the preset character range of the virtual support character, the moving speed of the virtual support character is n (where n>0); or if there are two virtual characters of the first camp within the preset character range of the virtual support character, the moving speed of the virtual support character is 2n.

In some embodiments, the second camp is a camp having a confrontation relationship with the first camp, and the second speed is associated with a virtual character of the second camp included in the preset character range of the virtual support character.

In some embodiments, the second speed is negatively correlated to a character quantity of virtual characters of the second camp included in the preset character range of the virtual support character. Exemplarily, if there are two virtual characters of the first camp and one virtual character of the second camp within the preset character range of the virtual support character, the moving speed of the virtual support character is n; or if there are four virtual characters of the first camp and two virtual characters of the second camp within the preset character range of the virtual support character, the moving speed of the virtual support character is 2n.

In an exemplary embodiment, when the virtual support character satisfies a second assistance condition, a second assistance animation of the virtual support character providing battle assistance for the second virtual character is displayed.

In some embodiments, the second assistance condition includes at least one of: an attribute value of a virtual support character being less than or equal to a preset attribute value, the second virtual character existing within a preset character range of the virtual support character, or the like.

In some embodiments, when an attribute value of the virtual support character is less than or equal to a preset attribute value, the second assistance animation of the virtual support character providing battle assistance for the second virtual character is displayed.

The attribute value includes at least one of a health value, an energy value, an attack power, a defense value, an attack speed, a movement speed, or the like. This is not limited in this embodiment of this application.

Exemplarily, if a health value of the virtual support character is less than or equal to a preset health value, it is determined that the virtual support character satisfies the second assistance condition. In this case, the second assistance animation of the virtual support character providing battle assistance for the second virtual character is displayed.

In some other embodiments, when the second virtual character is within the preset character range of the virtual support character, the second assistance animation of the virtual support character providing battle assistance for the second virtual character is displayed.

Exemplarily, if the second virtual character moves into the preset character range of the virtual support character, it is determined that the virtual support character satisfies the second assistance condition. In this case, the second assistance animation of the virtual support character providing battle assistance for the second virtual character is displayed.

In some other embodiments, when the attribute value of the virtual support character is less than or equal to the preset attribute value, and the second virtual character is within the preset character range of the virtual support character, the second assistance animation of the virtual support character providing battle assistance for the second virtual character is displayed.

Exemplarily, if a health value of the virtual support character is less than or equal to a preset health value, and the second virtual character moves into the preset character range of the virtual support character, it is determined that the virtual support character satisfies the second assistance condition. In this case, the second assistance animation of the virtual support character providing battle assistance for the second virtual character is displayed.

In some embodiments, when the attribute value of the virtual support character is less than or equal to the preset attribute value, and the second virtual character is within the preset character range of the virtual support character, in response to duration for which the second virtual character is within the preset character range of the virtual support character reaching second preset duration, the second assistance animation of the virtual support character providing battle assistance for the second virtual character is displayed. Exemplarily, if a health value of the virtual support character is less than or equal to a preset health value, and the second virtual character moves into the preset character range of the virtual support character, when duration for which the second virtual character stays within the preset character range reaches second preset duration, it is determined that the virtual support character satisfies the second assistance condition. In this case, the second assistance animation of the virtual support character providing battle assistance for the second virtual character is displayed.

In some embodiments, battle assistance provided by the virtual support character for the second virtual character includes at least one of: providing a bonus effect for the second virtual character, assisting the second virtual character by using a virtual skill or a virtual item, assisting the second virtual character by changing a corresponding movement state, or the like.

In some embodiments, a larger distance between the position of the virtual support character and the specified position is more beneficial to winning a battle of the second virtual character.

In some embodiments, when the virtual support character satisfies the second assistance condition, a health value bonus animation of the second virtual character is displayed, and the health value bonus animation is used as the second assistance animation.

Exemplarily, if the virtual support character satisfies the second assistance condition, the second virtual character obtains a health value bonus. The health value bonus is configured for increasing a health value of the second virtual character, so that a survival capability of the second virtual character in a virtual battle is increased.

In some embodiments, the health value bonus is a single bonus effect. Exemplarily, the virtual support character adds 20 health points to the second virtual character at a time.

Alternatively, the health value bonus is a multiple bonus effect lasting for a period of time. Exemplarily, the virtual support character provides a health value bonus lasting for three seconds to the second virtual character, and health points in a bonus each second are the same. For example, 5 health points are added to the second virtual character each second. Alternatively, health points in a bonus each second are different. For example, 2 health points are added at the first second, 5 health points are added at the second second, and 8 health points are added at the eighth second.

In some embodiments, when the virtual support character satisfies the second assistance condition, a movement animation of the virtual support character moving in a direction away from the specified position is displayed, and the movement animation is used as the second assistance animation.

Exemplarily, if the virtual support character satisfies the second assistance condition, the virtual support character moves away from the specified position to increase the distance between the position of the virtual support character and the specified position, to assist the second virtual character to win the battle.

In some embodiments, when the virtual support character satisfies the second assistance condition, a stop animation of the virtual support character stops moving is displayed, and the stop animation is used as the second assistance animation.

Exemplarily, if the virtual support character satisfies the second assistance condition, the virtual support character stops moving.

In some embodiments, when the virtual support character satisfies the second assistance condition, a movement animation of the virtual support character moving in a direction away from the specified position and a health value bonus animation of the second virtual character are displayed, and the movement animation and the health value bonus animation are used as the second assistance animation.

Exemplarily, if the virtual support character satisfies the second assistance condition, the virtual support character moves in a direction away from the specified position, and the virtual support character provides a health value bonus for the second virtual character.

In some embodiments, when the virtual support character satisfies the second assistance condition, a stop animation of the virtual support character stops moving and a health value bonus animation of the second virtual character are displayed, and the stop animation and the health value bonus animation are used as the second assistance animation.

Exemplarily, if the virtual support character satisfies the second assistance condition, the virtual support character stops moving, and the virtual support character provides a health value bonus for the second virtual character.

The foregoing processes describe assistance animation content of the virtual support character providing battle assistance for different virtual characters when the virtual support character satisfies different assistance conditions. In addition to being used as information for determining a battle result in a case of a virtual battle, the virtual support character may further provide battle assistance for virtual characters of multiple parties participating in the virtual battle. Under different assistance conditions, virtual characters assisted by the virtual support character are different, so that the virtual support character can fully participate in a whole battle process of the virtual character, and provide battle assistance for the virtual characters of multiple parties, thereby improving utilization of the virtual support character and impact of the battle result. Moreover, a process of providing battle assistance for different virtual characters under different assistance conditions greatly enriches interaction forms during a battle of a virtual character, and battle fairness is fully ensured by setting of a differentiation assisting process.

Operation 330: Display a first battle result in response to the virtual support character moving to the first position.

The first battle result is configured for indicating that the first virtual character wins a battle.

Exemplarily, the first virtual character is used as a virtual character configured for interacting with the virtual support character, to escort or transport the virtual support character to the first position when the first virtual character is in a virtual battle process. The first position is a position configured for ending the virtual battle. Therefore, when the virtual support character moves to the first position, it indicates that the first virtual character wins the battle.

In some embodiments, the first battle result is displayed in response to the virtual support character moving to the first position and a distance between the first position and a character destination position being less than or equal to a preset distance. The character destination position refers to a movement destination of the virtual support character preset in the virtual scene. Exemplarily, the first position is a position whose distance from the specified position is less than or equal to a preset distance in the virtual scene. The specified position is a movement destination position of the virtual support character, and the specified position may be any preset position in the virtual scene. In other words, the first position is not a fixed point. When the preset distance is relatively large, the first position may be a plurality of points on a range line corresponding to the preset distance, so that the virtual support character may move to a destination from a plurality of directions and positions, increasing a possibility that the virtual support character moves to the first position, accelerating battle progress, and improving efficiency of performing a virtual battle.

When the preset distance is 0, the first position is the specified position. Exemplarily, when the virtual support character moves to the specified position following the first virtual character, it is determined that the first virtual character wins a battle.

In some embodiments, that the virtual support character moves to the first position means that the virtual support character moves to the first position as an independent moving character. Alternatively, the virtual support character moves to the first position following the first virtual character. For example, the first virtual character moves to the first position carrying the virtual support character. In other words, when the first virtual character moves to the first position, it indicates that the virtual support character moves to the first position. Alternatively, only when the first virtual character moves, the virtual support character has a moving capability, and moves to the first position.

In some embodiments, the first battle result is displayed in response to the virtual support character moving to the first position and the attribute value of the first virtual character being greater than the preset attribute value.

Exemplarily, it is assumed that the health value is 0. In other words, if the virtual support character moves to the first position, and the health value of the first virtual character is greater than 0, the first virtual character wins a battle.

The foregoing content describes a condition for displaying the first battle result. The first position to which the virtual support character moves is used as a determining position of the first battle result, and may have a range, to avoid a problem that the virtual support character moves nearby the first position but cannot be effectively detected. In other words, by determining a relationship between the distance between the first position and a character destination position corresponding to the virtual support character and the preset distance, a specific effective range may be set for implementation of the first battle result, so that when the distance is less than the preset distance, the first battle result can be displayed, thereby resolving the accidental problem in a game process, encouraging the player to reach nearby the first position through interaction of the first virtual character with the virtual support character, and improving human-computer interaction efficiency.

In some embodiments, the virtual battle has corresponding battle duration. The battle duration refers to a time interval between a start moment of a virtual battle and a current moment. In other words, the battle duration is duration of a battle between the first virtual character and the second virtual character.

In some embodiments, when the battle duration is less than the preset duration, the first battle result is displayed in response to the virtual support character moving to the first position.

In some embodiments, when the battle duration is less than the preset duration, the first battle result is displayed in response to the virtual support character moving to the first position and the attribute value of the first virtual character being greater than the preset attribute value.

In some embodiments, when battle duration is less than preset battle duration, the first battle result is displayed in response to the virtual support character moving to the first position and a distance between the first position and a current position of the first virtual character being less than a distance between the first position and a current position of the second virtual character. Exemplarily, at the end of the battle, if the distance between the virtual support character and the first virtual character is less than the distance between the virtual support character and the second virtual character, the first virtual character wins the battle. If the distance between the virtual support character and the first virtual character is greater than the distance between the virtual support character and the second virtual character, the first virtual character loses the battle, and the second virtual character wins the battle.

The foregoing content describes another implementation of displaying the first battle result. The battle duration and the preset battle duration are introduced as a basis for determining the first battle result. When the battle duration is less than the preset battle duration, whether the first battle result is displayed may be summarized and analyzed according to the first position and the current position of the first virtual character and according to the first position and the current position of the second virtual character. In other words, whether the first position is closer to the first virtual character or the first position is closer to the second virtual character is determined based on using the virtual support character as a condition for determining the battle result, thereby enriching gameplay, enabling the player to pay attention to battle duration while paying attention to the virtual support character, and evaluating a battle result in multiple dimensions, to improve fun of the game.

In the foregoing embodiment, when the battle ends, values of distances between the virtual support character and the first virtual character and between the virtual support character and the second virtual character are compared, to determine the battle result of the first virtual character, so that the battle result is determined without a preset position, thereby saving computer resources. In addition, because the player needs to approach the virtual support character to win a battle, frequency of interaction between a virtual character and the virtual support character is improved to some extent, thereby improving utilization of the virtual support character.

In some embodiments, when the battle duration reaches the preset duration, a second battle result is displayed in response to the virtual support character not moving to the first position. The second battle result is configured for indicating that the first virtual character loses a battle. Exemplarily, it is assumed that the preset duration is two minutes, if the virtual support character does not move to the first position at the second minute after the virtual battle starts, the first virtual character loses the battle, and the second virtual character wins the battle.

In some embodiments, the second battle result is displayed in response to the virtual support character not moving to the first position and the attribute value of the first virtual character being less than or equal to the preset attribute value. Exemplarily, it is assumed that the health value is 0. In other words, if the virtual support character does not move to the first position, and the health value of the first virtual character is equal to 0, the first virtual character loses a battle, and the second virtual character wins the battle.

In conclusion, in the foregoing process, the battle result is determined according to whether the virtual support character with which the first virtual character interacts moves to the first position instead of completely depending on a fixed virtual object. The virtual support character is used as a character movable in the virtual scene, so that utilization of the virtual support character is relatively high. In addition, the virtual support character has relatively high impact on the battle result, avoiding a problem that there are few game interaction forms in which a virtual character moves a fixed virtual object, increasing fun of a game, and improving utilization of computer resources.

In some exemplary embodiments, the assistance condition includes a state condition. When satisfying different state conditions, the virtual support character enters different character states. In the different character states, the virtual support character may provide different battle assistance for the first virtual character or the second virtual character.

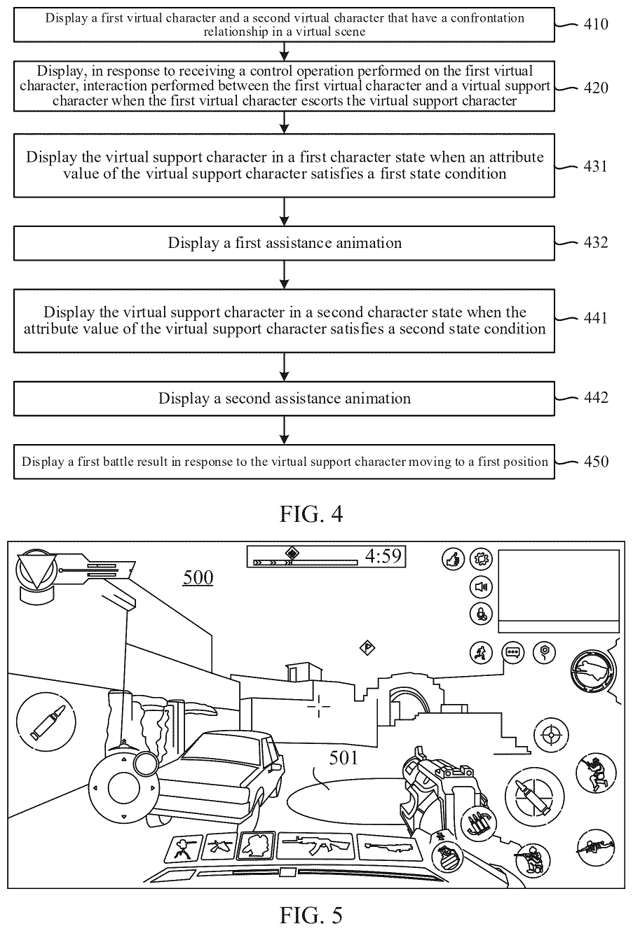

Exemplarily, as shown in FIG. 4, the embodiment shown in FIG. 3 may alternatively be implemented as the following operations 410 to 450.

Operation 410: Display a first virtual character and a second virtual character that have a confrontation relationship in a virtual scene.

The virtual scene includes a virtual support character. The virtual support character is configured for providing battle assistance for a virtual character.

The virtual scene is a battle scene in a virtual battle. The virtual scene is a scene displayed when an application is run. Exemplarily, the application may be implemented as a shooting game. The shooting game includes a first-person shooting game, a third-person shooting game, and the like.

In some embodiments, the virtual battle is a game in an attack-defense mode provided in the shooting game. The virtual battle includes a first camp and a second camp. The first virtual character belongs to the first camp, and the second virtual character belongs to the second camp. The first camp is an attacking party, and the second camp is a defending party.

For the attacking party, a condition for winning a virtual battle is escorting the virtual support character to a first position. The defending party needs to prevent the attacking party from escorting the virtual support character to the first position and consume energy (for example, a health value) of the virtual support character. During the battle, the two parties can formulate tactics and compete for victory in the virtual battle by using the states and skills of the virtual support characters.

The states of the virtual support character include a first character state and a second character state.

Exemplarily, the first character state of the virtual support character may be understood as a starting state. In the starting state, the virtual support character has a moving capability and can move toward the first position. When the virtual support character moves, a bonus effect, such as a moving speed bonus, may be provided for a nearby attacking party.

Exemplarily, the second character state of the virtual support character may be understood as a freezing state. In the freezing state, the virtual support character does not have a moving capability, that is, stays at a position in the virtual scene and cannot move. In addition, when the virtual support character is in the freezing state, a bonus effect, such as a defense bonus, may be provided for a nearby attacking party.

In some embodiments, a virtual battle is started by using a battle start operation.

Exemplarily, after a virtual battle is started, the virtual support character is displayed at any position in a virtual scene corresponding to the virtual battle. Alternatively, the virtual support character is displayed at a specified position in a virtual scene corresponding to the virtual battle, and a preset character range (namely, the preset character range of the virtual support character) corresponding to the specified position includes the first virtual character (or any virtual character of the first camp).

Alternatively, before a current virtual battle is started, there is a historical virtual battle in which the first virtual character fights against the second virtual character, and a display position of the virtual support character in a virtual scene corresponding to the current virtual battle is determined according to a battle result of the historical virtual battle. The battle result of the historical virtual battle is associated with the current battle, so that an association degree between the display position of the virtual support character and the battle result is increased, and interaction between the player and the virtual support character is increased. In addition, compared with a manner of randomly determining the display position of the virtual support character, a manner of determining the display position of the virtual support character according to the battle result is more proper, thereby facilitating battle fairness.

The foregoing content describes displaying content of the first virtual character and the second virtual character by using a historical battle result. The historical battle result, as a result of a battle between the first virtual character or the second virtual character within a historical time period, can reflect a historical battle performance of the first virtual character or the second virtual character, and when the historical battle result indicates that the first virtual character win the battle, the first virtual character is displayed near the second position by default, to encourage, by using a historical win situation, the player to control the first virtual character to continue to win a current virtual battle. This enriches implementations of a game incentive mechanism, provides a default configuration process for a start process of a game, and improves calculation resource efficiency.

In some embodiments, the first virtual character has a corresponding historical virtual battle, and the historical virtual battle has a corresponding historical battle result. A battle start operation is received, where the battle start operation is configured for starting a first virtual battle.

In response to the battle start operation when the historical battle result indicates that the first virtual character wins a battle, the first virtual character and the second virtual character that have the confrontation relationship are displayed in the virtual scene. A second position in the virtual scene includes the virtual support character, and the first virtual character is within a preset character range corresponding to the second position.

Exemplarily, if the first virtual character wins the historical virtual battle, the virtual support character is displayed at the second position in the virtual scene corresponding to the virtual battle. The preset character range corresponding to the second position includes the first virtual character (or any virtual character of the attacking party).

The foregoing content describes another implementation of displaying a virtual character by using a historical battle result. When the historical battle result indicates that the first virtual character loses a battle, the first virtual character is displayed by default near a third position corresponding to the virtual support character, to encourage, by using a historical failure, the player to control the first virtual character to win the current virtual battle, to avoid a problem that the player loses game interest due to that the second virtual character continuously holds an initiative. When a default configuration process is provided for a start process of a game, relationships between different virtual characters and the virtual support character are coordinated.

In some embodiments, the historical virtual battle has corresponding historical battle duration, where the historical battle duration is duration consumed by the first virtual character for winning a battle. In response to the battle start operation when the historical battle result indicates that the first virtual character wins a battle, the first virtual character and the second virtual character that have the confrontation relationship are displayed in the virtual scene. A fourth position in the virtual scene includes the virtual support character, and a distance between the fourth position and a current position of the first virtual character is positively correlated to the historical battle duration.

In some embodiments, when the first virtual character wins the historical virtual battle, a time consumed by the first virtual character in the historical virtual battle is the historical battle duration. After the current virtual battle is started, a first initial distance between the display position of the virtual support character and the position of the first virtual character is determined according to the historical battle duration. The historical battle duration is positively correlated to the first initial distance.

The foregoing content describes a situation of a relative distance between the first virtual character and the fourth position corresponding to the virtual support character in a current virtual battle determined flexibly according to the historical battle duration. If the historical battle duration of a battle won by the first virtual character is relatively short, a position is relatively close; or if the historical battle duration of a battle won by the first virtual character is relatively long, the position is relatively far. A manner of determining the display position of the virtual support character is refined, and accuracy of the determined display position of the virtual support character is improved. The player can also be encouraged to positively fight in each virtual battle, thereby improving fine granularity of the determined display position while improving activeness of the game.

Alternatively, in response to the battle start operation, the first virtual character and the second virtual character that have the confrontation relationship are displayed in the virtual scene when the historical battle result indicates that the first virtual character loses a battle. The third position in the virtual scene includes the virtual support character, and the first virtual character is outside a preset character range corresponding to the third position.

Exemplarily, if the first virtual character loses the historical virtual battle, the virtual support character is displayed at the third position in the virtual scene corresponding to the virtual battle. The preset character range corresponding to the third position does not include the first virtual character (or does not include any virtual character of the first camp).

Exemplarily, FIG. 5 is a schematic diagram of a battle interface of a virtual battle. As shown in FIG. 5, in a virtual scene 500 corresponding to the virtual battle, a position 501 is a display position of a virtual support character, and a preset range of the position 501 includes a virtual character of a first camp (namely, an attacking party).

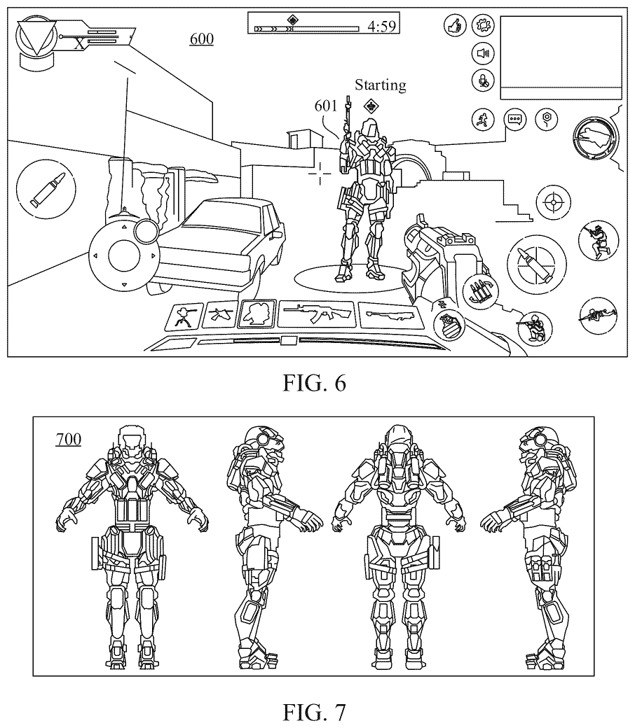

In some embodiments, the virtual support character includes a virtual robot. Exemplarily, FIG. 6 is a schematic diagram of a virtual robot in a virtual scene. As shown in FIG. 6, in a virtual scene 600 corresponding to the virtual battle, a virtual robot 601 is displayed near a virtual character of a first camp (namely, an attacking party).

In some embodiments, the virtual robot is a virtual character controlled by a system, for example, a non-player character (NPC) or an artificial intelligence (AI) character. That is, the virtual robot is not a manually controlled character but a character that automatically performs activities.

Exemplarily, FIG. 7 is a schematic diagram of an appearance design of a virtual robot. As shown in FIG. 7, a front face, a left side face, a back face, and a right side face of the virtual robot are presented on an appearance presentation interface 700. In some embodiments, an appearance of the virtual robot may be designed by a game developer and released in the game; or an appearance of the virtual robot may be set by a player in the game.

In some embodiments, after a virtual battle is started, a virtual support character is displayed at a position preset by a player in a virtual scene corresponding to the virtual battle.

Operation 420: Display, in response to receiving a control operation performed on the first virtual character, interaction performed between the first virtual character and the virtual support character when the first virtual character escorts the virtual support character.

Exemplarily, the controlling the first virtual character to interact with the virtual support character includes: controlling the first virtual character to carry the virtual support character, controlling the first virtual character to approach the virtual support character, controlling the first virtual character to interact (for example, chat) with the virtual support character, controlling the first virtual character to protect the virtual support character, controlling the first virtual character to complete a task released by the virtual support character, or the like. This is not limited in this embodiment of this application.

In some embodiments, a movement control operation performed on the first virtual character is received. The movement control operation is configured for controlling the first virtual character to move toward a position of the virtual support character.

Operation 431: Display the virtual support character in a first character state when an attribute value of the virtual support character satisfies a first state condition.

The first assistance condition includes the first state condition, and the first state condition is a condition corresponding to the attribute value of the virtual support character.

In some embodiments, the virtual support character in the first character state is displayed in response to the attribute value of the virtual support character being greater than a preset attribute value.

Exemplarily, the attribute value may be implemented as a health value, and the preset attribute value may be implemented as 0. In response to that the health point of the virtual support character is greater than 0, the virtual support character in the first character state is displayed, that is, the virtual support character in a starting state is displayed. In some embodiments, after the virtual battle is started, if the virtual support character is not attacked, an attribute value of the virtual support character is an initial attribute value, and the initial attribute value is greater than a preset attribute value. That is, after the virtual battle is started, the virtual support character is in the first character state. The virtual support character has a moving capability in the first character state. In other words, the virtual support character in the first character state has a capability of moving in the virtual scene.

In the foregoing content, the attribute value of the virtual support character is introduced as a basis for determining the first state condition. The attribute value, as attribute information only belonging to the virtual support character, is reference information for quantizing and considering the virtual support character. Whether the virtual support character satisfies the first state condition can be analyzed in detail by using the attribute value, thereby improving determining accuracy of the first state condition. Under the condition that the attribute value is considered, when the attribute value of the virtual support character is greater than the preset attribute value, the virtual support character in the first character state may be displayed, so that the preset attribute value is used as a determining factor for distinguishing between the character states of the virtual support character, thereby helping quantify and consider whether the virtual support character satisfies the first state condition, and improving determining accuracy of character state conversion.

Operation 432: Display a first assistance animation.

The first assistance animation is an animation of the virtual support character in the first character state providing battle assistance for the first virtual character. Exemplarily, when the virtual support character is in the first character state, the first assistance animation is displayed.

In some embodiments, the first assistance animation includes at least one of a first movement animation, a first attribute value bonus animation, or the like.

The first movement animation is an animation of the virtual support character in the first character state moving toward the first position; and the first attribute value bonus animation is an animation of the virtual support character in the first character state performing an attribute value bonus on the first virtual character.

In some embodiments, in response to the virtual support character being in the first character state, the first assistance animation is displayed.

Exemplarily, when the first virtual character is within the preset character range of the virtual support character, the first movement animation is displayed as the first assistance animation, and/or the first attribute value bonus animation are/is displayed as the first assistance animation.

In some embodiments, in response to the virtual support character being in the first character state, when the first virtual character is within the preset character range of the virtual support character, the first assistance animation is displayed.

Exemplarily, in response to the virtual support character is in the first character state, when the first virtual character is in the preset character range of the virtual support character, the first movement animation is displayed, and/or the first attribute value bonus animation are/is displayed.

Exemplarily, if the virtual support character is in the first character state, and the first virtual character is within the preset character range of the virtual support character, the virtual support character moves toward the first position to reduce a distance between the position of the virtual support character and the first position, to assist the first virtual character to win the battle; and/or, the first virtual character obtains an attribute value bonus, to improve a capability of battling by the first virtual character against a character of the second camp.

In the foregoing content, the virtual support character in the first character state is used as a condition for displaying the first assistance animation, and whether the first virtual character is within the preset character range corresponding to the virtual support character is further determined, so that the preset character range is used as a determining factor for implementing the first assistance animation. When the first virtual character is within the preset character range, the first movement animation of the virtual support character moving toward the first position may be displayed. Because a game objective of the first virtual character is to escort the virtual support character to the first position, the first movement animation of the virtual support character automatically moving toward the first position may provide a good battle assistance effect for the first virtual character, so that it is convenient for the player to obtain a battle result indicating a win of the battle, thereby improving human-computer interaction efficiency by using a moving process of the virtual support character having a moving function.

In some embodiments, if the first assistance animation is implemented as the first movement animation, a detour animation is displayed in response to a movement route of the virtual support character including a first obstacle. The first obstacle is an obstacle at a fixed position in the virtual scene, and the detour animation is an animation of the virtual support character moves toward the first position after bypassing the first obstacle.

A collision animation is displayed in response to a movement route of the virtual support character including a second obstacle. The second obstacle is a movable obstacle in the virtual scene, and the collision animation is an animation of the virtual support character forcibly knocking away the second obstacle and then moves toward the first position.

In some other embodiments, a character standing animation is displayed when the first virtual character is outside the preset character range of the virtual support character. The character standing animation is an animation of the virtual support character standing in the virtual scene. Exemplarily, if the first virtual character is outside the preset character range of the virtual support character, although the virtual support character has a moving capability, the virtual support character does not move, and only stands in the virtual scene.

The foregoing content describes content that the character standing animation is displayed when the first virtual character is in the first character state but is outside the preset character range. When the first virtual character is outside the preset character range corresponding to the virtual support character, in this case, it is considered that the first virtual character cannot support the virtual support character in keeping a position moving process. Therefore, although the virtual support character is in the first character state, the virtual support character still cannot move in a targeted manner toward the first position according to thoughts of the player, and instead, is presented in a static state. The player may be prompted to control the first virtual character to be within the preset character range by using the character standing animation, to implement an effective interaction process between the first virtual character and the virtual support character. This improves fun of the game, and is convenient for the player to control a moving process of the first virtual character in the virtual scene based on the virtual support character in a targeted manner.

According to the foregoing operation 431 and operation 432, when the virtual support character satisfies the first state condition, the virtual support character in the first character state may be displayed, to represent that the virtual support character has a moving capability in the virtual scene, and the first assistance animation may be displayed, to represent that the virtual support character in the first character state provides battle assistance for the first virtual character in the virtual scene. Therefore, an assistance status provided by the virtual support character for the first virtual character is differently determined according to the attribute value of the virtual support character, thereby enriching application effects of the virtual support character in the game, improving gameplay, and improving interest of a player in participating in a virtual battle by using the first virtual character.

Operation 441: Display the virtual support character in a second character state when an attribute value of the virtual support character satisfies a second state condition.

The second assistance condition includes the second state condition, and the second state condition is a condition corresponding to the attribute value of the virtual support character.

In some embodiments, the virtual support character in the second character state is displayed in response to the attribute value of the virtual support character being less than or equal to a preset attribute value.

Exemplarily, in operation 441, when the attribute value of the virtual support character is greater than the preset attribute value, it indicates that the virtual support character is in the first character state. In this case, if a virtual character of the second camp (namely, the defending party) attacks the virtual support character, to cause the attribute value of the virtual support character to be less than or equal to the preset attribute value, for example, a health value of the virtual support character becomes 0 due to an attack, the virtual support character enters the second character state.

In some embodiments, the virtual support character in the second character state does not have a capability of moving in the virtual scene.

In the foregoing content, the attribute value of the virtual support character is introduced as a basis for determining the second state condition, and whether the virtual support character satisfies the second state condition may be analyzed in detail by using the attribute value. When the attribute value of the virtual support character does not reach the preset attribute value, the virtual support character in the first character state may be displayed, so that the preset attribute value is used as a determining factor for distinguishing between the character states of the virtual support character, thereby helping quantify and consider whether the virtual support character satisfies the second state condition, and improving determining accuracy of character state conversion.

Operation 442: Display a second assistance animation.

The second assistance animation is an animation of the virtual support character in the second character state providing battle assistance for the second virtual character.

In some embodiments, the second assistance animation includes at least one of a character freezing animation, a second movement animation, a second attribute value bonus animation, or the like.

The character freezing animation is configured for indicating that the virtual support character loses a moving capability in the virtual scene; the second movement animation is an animation of the virtual support character in the second character state moving in a direction away from the first position; and the second attribute value bonus animation is an animation of the virtual support character in the second character state performing an attribute value bonus on the second virtual character.

In some embodiments, in response to the virtual support character being in the second character state, the second assistance animation is displayed.

In some embodiments, in response to the virtual support character being in the second character state, when the second virtual character is within the preset character range of the virtual support character, the second assistance animation is displayed.

In some embodiments, in response to the virtual support character being in the second character state, the character freezing animation or the second movement animation is displayed; and when the second virtual character is within the preset character range of the virtual support character, the second attribute value bonus animation is displayed.

Exemplarily, if the health value of the virtual support character becomes 0 due to an attack, the virtual support character enters the second character state, and the virtual support character stops moving toward the first position or moves toward a direction away from the second position. In this case, if the second virtual character is within the preset character range of the virtual support character, the second virtual character obtains an attribute value bonus to improve a capability of fighting against a character of the first camp.

In some embodiments, the second character state of the virtual support character may be understood as a freezing state. If the virtual support character in the freezing state needs to be started, an activation process needs to be entered, and the virtual support character in the activation process is in a third character state, or referred to as an activated state. After the activation process is completed, the virtual support character is switched from the third character state to the first character state.

The foregoing content describes an exemplary implementation of the second assistance animation. When the attribute value of the virtual support character satisfies the second state condition, the virtual support character in the second character state may be displayed, and the second assistance animation implemented as the character freezing animation or the second movement animation may be further displayed. The character freezing animation can directly represent a situation in which the virtual support character loses the moving capability, helping the player to more targetedly grasp a current state of the virtual support character. The second movement animation describes a status in which the virtual support character assists the second virtual character, and reflects a process in which the virtual support character may move in an opposite direction of the first position corresponding to the first virtual character, to assist the second virtual character in preventing the first virtual character from achieving the game objective. This encourages a player to control the first virtual character to compete for initiative of the virtual support character, thereby making full use of a moving function of the virtual support character and improving human-computer interaction efficiency while improving fun of the game.

In some embodiments, when the virtual support character satisfies a third state condition, the virtual support character in a third character state and a first switching animation are displayed.

The third character state is an intermediate character state in a switching process of switching from the second character state to the first character state. The first switching animation is configured for switching the virtual support character from the third character state to the first character state, and the first switching animation corresponds to first switching duration.

In some embodiments, the virtual support character in the third character state and the first switching animation are displayed in response to duration for which the virtual support character is in the second character state reaching preset duration.

In some embodiments, in response to the duration for which the virtual support character is in the second character state reaching the preset duration and within the preset duration, the virtual support character being not attacked by a virtual character of the second camp, the virtual support character in the third character state and the first switching animation are displayed.

Exemplarily, after entering the freezing state, if not attacked within 10s, the virtual support character enters an activation process, and is in the activated state (namely, the third character state) in this case. In the activated state, an attribute value recovery animation (namely, the first switching animation) is displayed. If the virtual support character is not attacked in this period, the first switching duration is duration for which the virtual support character recovers from the attribute value of the virtual support character entering the freezing state to an attribute value of a specified value. The attribute value of the specified value is greater than a preset attribute value.

In other words, an attribute value (namely, the attribute value of the specified value) of the virtual support character after restoration is greater than the preset attribute value, that is, a restored virtual support character is in the first character state.

In some embodiments, the virtual support character in the third character state and the second switching animation are displayed in response to duration for which the virtual support character is in the second character state reaching preset duration when the first virtual character is within the preset character range of the virtual support character.

The second switching animation is configured for switching the virtual support character from the third character state to the first character state, and the second switching animation corresponds to second switching duration. The first switching duration is greater than the second switching duration.

In some embodiments, in the second character state reaching preset duration and within the preset duration and the virtual support character being not attacked by a virtual character of the second camp, when the first virtual character is within the preset character range of the virtual support character, the virtual support character in the third character state and the second switching animation are displayed in response to duration of the virtual support character.

Exemplarily, after entering the freezing state, if not attacked within 10s, the virtual support character enters an activation process, and is in the activated state (namely, the third character state) in this case. In the activated state, if a virtual character of the attacking party is in the preset character range of the virtual support character, an attribute value acceleration recovery animation (namely, the second switching animation) is displayed. If the virtual support character is not attacked in this period, the second switching duration is recovery duration for which the virtual support character recovers from the attribute value of the virtual support character entering the freezing state to an attribute value of a specified value. The attribute value of the specified value is greater than the preset attribute value.

In some embodiments, if in the activating process, the virtual support character is attacked by a virtual character of the second camp, an attribute value decrease animation of an attribute value that is being restored of the virtual support character is displayed. When the attribute value of the virtual support character decreases to be less than or equal to the preset attribute value, the virtual support character re-enters the freezing state (namely, the second character state).

Alternatively, in the activation process, the virtual support character is attacked by a virtual character of the second camp, playing of the attribute value recovery (or acceleration recovery) animation is stopped, and the virtual support character re-enters the freezing state.

The foregoing content describes content of adjusting the character state of the virtual support character and displaying the switching animation according to a relationship between the duration of the second character state and the preset duration. When duration for which the virtual support character is in the second character state reaches the preset duration, the virtual support character may be adjusted to the third character state, to gradually adjust the virtual support character in the second character state to the virtual support character in the first character state, to avoid a problem that the first virtual character cannot execute a game process because the virtual support character assists the second virtual character for a long time. This provide fairness for a virtual battle between the first virtual character and the second virtual character. In addition, a condition that the first virtual character is within the preset character range is introduced as a condition for displaying the virtual support character in the third character state, to provide a restriction condition for state conversion of the virtual support character, and is beneficial to encouraging the player to control the first virtual character to compete for initiative of the virtual support character, so that a process of displaying the second switching animation is more battle-related than the process of displaying the first switching animation, and a sense of game participation of the player is improved.

According to the foregoing operation 441 and operation 442, when the virtual support character satisfies the second state condition, the virtual support character in the second character state may be displayed, and the second assistance animation may be further displayed, to represent that the virtual support character in the second character state provides battle assistance for the second virtual character in the virtual scene. The second state condition is used as a condition in which the first virtual character differently provides battle assistance for different virtual characters, and a status in which the virtual support character provides assistance for the second virtual character may be determined according to the attribute value, to enrich an application effect of the virtual support character in a game, and improve gameplay. This facilitates a player avoiding, by controlling the first virtual character, a process in which the virtual support character assists the second virtual character, thereby improving a sense of game participation of the player.

Operation 450: Display a first battle result in response to the virtual support character moving to the first position.

The first battle result is configured for indicating that the first virtual character wins a battle.

In some embodiments, the virtual battle has corresponding battle duration. The battle duration refers to a time interval between a start moment of a virtual battle and a current moment.

In some embodiments, when the battle duration is less than the preset duration, the first battle result is displayed in response to the virtual support character moving to the first position.

In some embodiments, when the battle duration reaches the preset duration, a second battle result is displayed in response to the virtual support character not moving to the first position. The second battle result is configured for indicating that the first virtual character loses a battle.

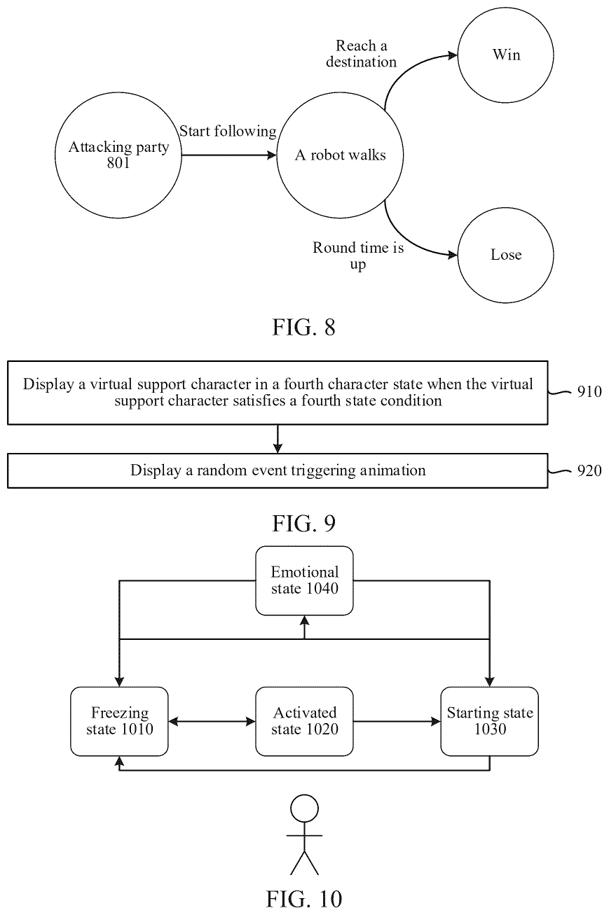

Exemplarily, an example in which the virtual support character is implemented as a virtual robot is used for description. FIG. 8 is a schematic diagram of a robot running rule. FIG. 8 represents a running rule of a robot. The running rule includes: when a first virtual character of an attacking party 801 is within a preset character range of a virtual support character, and a health point of the robot does not run out, the robot starts following, that is, the robot walks, and approaches a destination. When the robot reaches the destination, the first virtual character wins. It is assumed that a round time of the virtual battle is two minutes. At the second minute after the virtual battle is started, the robot still does not move to the destination. In this case, the first virtual character loses.

In conclusion, in the foregoing process, the battle result is determined according to whether the virtual support character with which the first virtual character interacts moves to the first position instead of completely depending on a fixed virtual object. The virtual support character is used as a character movable in the virtual scene, so that utilization of the virtual support character is relatively high. In addition, the virtual support character has relatively high impact on the battle result, avoiding a problem that there are few game interaction forms in which a virtual character moves a fixed virtual object, increasing fun of a game, and improving utilization of computer resources.

According to the method provided in this embodiment of this application, when the attribute value of the virtual support character satisfies the first state condition or the second state condition, the virtual support character in the first character state or the second character state is displayed, and battle assistance is provided for the first virtual character or the second virtual character. The player can learn an assistance object of the virtual support character in this case by displaying the character state, so that the player can better formulate battle tactics, and human-computer interaction efficiency is improved while utilization of the virtual support character is improved.

According to the method provided in this embodiment of this application, when the attribute value of the virtual support character is greater than the preset attribute value, it is determined that the virtual support character enters the first character state; or when the attribute value of the virtual support character is less than or equal to the preset attribute value, it is determined that the virtual support character enters the second character state. The state of the virtual support character is controlled by using the attribute value, so that the state of the virtual support character is relatively easily controlled, thereby improving efficiency of controlling the virtual support character.

According to the method provided in this embodiment of this application, when the attribute value of the virtual support character is greater than the preset attribute value, if the first virtual character controlled by the player is within the preset character range of the virtual support character in this case, the movement animation of the virtual support character moving toward the first position is displayed. The virtual support character moving toward the first position helps the first virtual character wins a battle, and accelerates battle progress. In addition, the virtual support character is triggered to move by using the position of the first virtual character, thereby increasing interactivity between the player and the virtual support character, and improving human-computer interaction efficiency.

According to the method provided in this embodiment of this application, when the attribute value of the virtual support character is greater than the preset attribute value, if the first virtual character controlled by the player is within the preset character range of the virtual support character in this case, the standing animation of the virtual support character is displayed. To some extent, this causes the first virtual character to move toward the virtual support character, thereby further increasing interactivity between the player and the virtual support character.

According to the method provided in this embodiment of this application, when the attribute value of the virtual support character is less than or equal to the preset attribute value, the character freezing animation or the second movement animation is displayed. In other words, the virtual support character moves in an opposite direction of the first position or does not move. That is, the virtual support character can provide battle assistance for the second virtual character, thereby facilitating battle fairness.

According to the method provided in this embodiment of this application, when duration for which the virtual support character is in the second character state reaches the preset duration, the virtual support character in the third character state is displayed, and the switching animation of switching from the third character state to the first character state is displayed. That is, the virtual support character can automatically perform state switching under a specific condition, thereby improving intelligence and efficiency of the virtual support character in a state switching process.

According to the method provided in this embodiment of this application, when duration for which the virtual support character is in the second character state reaches the preset duration and the first virtual character is within the preset character range of the virtual support character, the switching process of switching from the third character state to the first character state is accelerated, and the first virtual character is enabled to move toward the virtual support character, further increasing interactivity between a player and the virtual support character.

In some exemplary embodiments, the state of the virtual support character further includes a fourth character state, and the fourth character state of the virtual support character may be understood as an emotional state. In the emotional state, a random event corresponding to the virtual support character is triggered. Exemplarily, as shown in FIG. 9, the embodiment shown in FIG. 4 further includes the following operation 910 and operation 920. Operation 910 and operation 920 are performed before operation 450.

Operation 910: Display the virtual support character in a fourth character state when the virtual support character satisfies a fourth state condition.

In some embodiments, the virtual support character in the fourth character state is displayed in response to a number of times the virtual support character is switched to a character state reaching a preset number in a preset time period. The character state to which the virtual support character is switched is at least one of the first character state, the second character state, or the third character state.

Exemplarily, if a robot is activated and freezes repeatedly within a short time (for example, entering a same state twice within one minute, e.g., activated-freezing-activated, or freezing-activated-freezing), the robot enters the fourth character state.

In some embodiments, the virtual support character in the fourth character state is configured for providing battle assistance for the first virtual character or the second virtual character; or is configured for providing battle assistance for the first virtual character and the second virtual character.

Operation 920: Display a random event triggering animation.

The random event triggering animation is configured for triggering random battle assistance in the virtual scene.

In some embodiments, the random event triggering animation is displayed based on the virtual support character in the fourth character state and a random event. The random event is randomly determined by the server from a plurality of candidate events in an event library.

Exemplarily, when the virtual support character is in the fourth character state, the random event is triggered. The random event includes: randomly generating a bombing area in a virtual scene, where the bombing area has attack impact on the first virtual character or the second virtual character, or the bombing area has attack impact on the first virtual character and the second virtual character; randomly selecting a teleportation point in the virtual scene, where the virtual support character is to be teleported to the teleportation point; and the virtual support character obtaining an acceleration/deceleration effect, and the like. An event type of the random event is not limited in this embodiment of this application.

In some embodiments, before the virtual support character in the fourth character state is displayed, that is, before the emotional state is triggered, the virtual support character is in a character state (where the character state herein is any one of the first character state, the second character state, the third character state, or the like); and the state switching animation is displayed after the random event triggering animation is triggered, where the state switching animation is configured for switching the virtual support character from the fourth character state to another character state.

Exemplarily, FIG. 10 is a schematic diagram of state switching. As shown in FIG. 10, a robot (that is, the virtual support character) is a key resource point in a virtual battle. For four states of the robot, battle assistance may be provided to a virtual character participating in a battle.

In some embodiments, various states of the robot are implemented by using a state machine: a freezing state (that is, the second character state) 1010, an activated state (that is, the third character state) 1020, a starting state (that is, the first character state) 1030, and an emotional state (that is, the fourth character state) 1040 of the robot are defined.

In the starting state 1030, if the attacking party is within a preset range corresponding to the robot (that is, the preset character range of the virtual support character), the robot walks toward a destination. In a walking process, the robot continuously provides an attribute value bonus to the attacking party. In the starting state 1030, if the attacking party is outside the preset range corresponding to the robot, the robot stands and does not walk.

In the activated state 1020, the robot does not provide battle assistance, but the activated state may be interrupted by the defending party. In other words, attacking the robot by the defending party may interrupt an activating process of the robot. Alternatively, the activated state may be accelerated by the attacking party. In other words, the attacking party is within a preset range corresponding to the robot, and the robot may accelerate an activating process (which is from the activated state 1020 to the starting state 1030).

In the freezing state 1010, the robot provides an attribute value bonus to the defending party, and in this case, the robot does not have a walking capability, that is, stops walking.

In the emotional state 1040, the server randomly selects one skill from the three skills, and the robot uses the skill.

In FIG. 10, switching from the freezing state 1010 to the activated state 1020 is automatically started by the robot. If the robot is not attacked within 10s, the activating process is entered, that is, the activated state 1020 is entered. If the activating process is completed, the starting state 1030 is entered; or if the activating process is interrupted, the freezing state 1010 is entered. If the robot is attacked to cause a health value to be 0 in the starting state 1030, the freezing state 1010 is entered. When switching is frequently performed between the freezing state 1010/the activated state 1020/the starting state 1030, the emotional state 1040 is entered. In the emotional state 1040, after a skill is released, the robot returns to a state before the robot enters the emotional state 1040.

In the method provided in this embodiment of this application, the fourth state condition is additionally introduced as a condition for adjusting the character state of the virtual support character, so that when the virtual support character satisfies the fourth state condition, the character state of the virtual support character is converted into the fourth character state and the random event is triggered. That is, a dynamic event is introduced into a virtual battle by using the virtual support character, thereby increasing tension and challenge of the battle. In addition, utilization of the virtual support character is further improved.

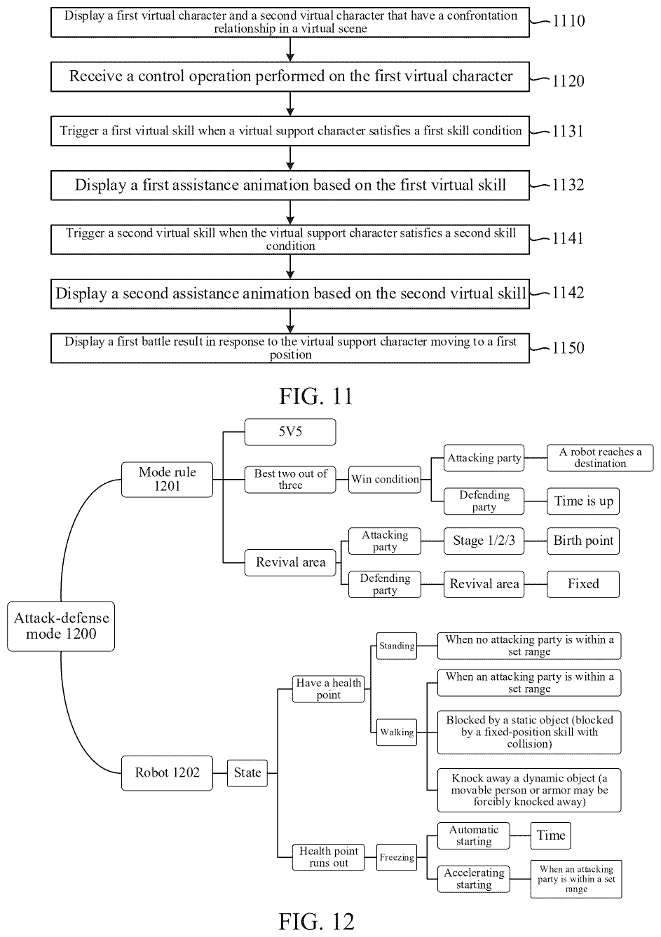

In some exemplary embodiments, the assistance condition further includes a skill condition or an item condition. When the virtual support character satisfies different skill conditions or item conditions, different virtual skills or virtual items are triggered, and the virtual support character may provide different battle assistance to the first virtual character or the second virtual character by using the different virtual skills or virtual items. For example, as shown in FIG. 11, the embodiment shown in FIG. 3 may alternatively be implemented as the following operations 1110 to 1150.

Operation 1110: Display a first virtual character and a second virtual character that have a confrontation relationship in a virtual scene.

The virtual scene includes a virtual support character. The virtual support character is configured for providing battle assistance for a virtual character.

In some embodiments, the virtual battle is a game in an attack-defense mode provided in the shooting game. The virtual battle includes a first camp and a second camp. The first virtual character belongs to the first camp, and the second virtual character belongs to the second camp. The first camp is an attacking party, and the second camp is a defending party.

Operation 1120: Receive a movement control operation performed on the first virtual character.

The control operation is configured for controlling the first virtual character to interact with the virtual support character.

In some embodiments, a movement control operation performed on the first virtual character is received. The movement control operation is configured for controlling the first virtual character to move toward a position of the virtual support character.

Operation 1131: Trigger a first virtual skill when the virtual support character satisfies a first skill condition.

In some other embodiments, a first virtual item is triggered when the virtual support character satisfies a first item condition.

In some embodiments, the virtual skill includes at least one of a virtual treatment skill, a virtual attack skill, a virtual defense skill, or the like; and the virtual item includes at least one of a virtual treatment item, a virtual attack item, a virtual defense item, or the like.

In some embodiments, the first skill condition or the first item condition includes at least one of: an attribute value of a virtual support character being greater than a preset attribute value, the first virtual character existing within a preset character range of the virtual support character, or the like. Exemplarily, the first virtual skill and/or the first virtual item are/is triggered when the attribute value of the virtual support character is greater than the preset attribute value; or the first virtual skill and/or the first virtual item are/is triggered when the first virtual character is within the preset character range of the virtual support character; or the first virtual skill and/or the first virtual item are/is triggered when the attribute value of the virtual support character is greater than the preset attribute value and the first virtual character is within the preset character range of the virtual support character.

Operation 1132: Display a first assistance animation based on the first virtual skill.

The first assistance animation is an animation of the virtual support character using the first virtual skill to provide battle assistance for the first virtual character.

In some other embodiments, the first assistance animation is displayed based on the first virtual item. The first assistance animation is an animation of the virtual support character using the first virtual item to provide battle assistance for the first virtual character.

Operation 1141: Trigger a second virtual skill when the virtual support character satisfies a second skill condition.

In some other embodiments, a second virtual item is triggered when the virtual support character satisfies a second item condition.

In some embodiments, the virtual skill includes at least one of a virtual treatment skill, a virtual attack skill, a virtual defense skill, or the like; and the virtual item includes at least one of a virtual treatment item, a virtual attack item, a virtual defense item, or the like.

In some embodiments, the second skill condition or the second item condition includes at least one of: an attribute value of a virtual support character being less than or equal to a preset attribute value, the second virtual character existing within a preset character range of the virtual support character, or the like. Exemplarily, the second virtual skill and/or the second virtual item are/is triggered when the attribute value of the virtual support character is less than or equal to the preset attribute value; or the second virtual skill and/or the second virtual item are/is triggered when the second virtual character is within the preset character range of the virtual support character; or the second virtual skill and/or the second virtual item are/is triggered when the attribute value of the virtual support character is less than or equal to the preset attribute value and the second virtual character is within the preset character range of the virtual support character.

Operation 1142: Display a second assistance animation based on the second virtual skill.

The second assistance animation is an animation of the virtual support character using the second virtual skill to provide battle assistance for the second virtual character.

In some other embodiments, the second assistance animation is displayed based on the second virtual item. The second assistance animation is an animation of the virtual support character using the second virtual item to provide battle assistance for the second virtual character.

Operation 1150: Display a first battle result in response to the virtual support character moving to the first position.

The first battle result is configured for indicating that the first virtual character wins a battle.

In some embodiments, the virtual battle has corresponding battle duration. The battle duration refers to a time interval between a start moment of a virtual battle and a current moment.

In some embodiments, when the battle duration is less than the preset duration, the first battle result is displayed in response to the virtual support character moving to the first position. The preset duration is a preset total battle duration of a virtual battle.

In some embodiments, when the battle duration reaches the preset duration, a second battle result is displayed in response to the virtual support character not moving to the first position. The second battle result is configured for indicating that the first virtual character loses a battle.

In conclusion, in the foregoing process, the battle result is determined according to whether the virtual support character with which the first virtual character interacts moves to the first position instead of completely depending on a fixed virtual object. The virtual support character is used as a character movable in the virtual scene, so that utilization of the virtual support character is relatively high. In addition, the virtual support character has relatively high impact on the battle result, avoiding a problem that there are few game interaction forms in which a virtual character moves a fixed virtual object, increasing fun of a game, and improving utilization of computer resources.

In some exemplary embodiments, the virtual battle is implemented as an attack-defense mode battle. The first virtual character is an attacking party, and the second virtual character is a defending party. Both the attacking party and the defending party can see a position and a state of a robot. A mode setting of an attack-defense mode is described below. Exemplarily, FIG. 12 is a schematic diagram of an overall setting of an attack-defense mode. As shown in FIG. 12, an attack-defense mode 1200 is designed with a mode rule 1201 and a robot 1202 (that is, the foregoing virtual support character).

For the mode rule 1201, in the attack-defense mode, a battle is a 5V5 multi-person battle, and victory or defeat is determined by multiple rounds of battles, that is, the above-mentioned virtual battle is played three times, using a system of best two out of three (a total of three rounds of attack-defense rotation, where the third round is an extra round). Within round time of a single virtual battle (or a single round), the attacking party wins if a robot reaches a destination. If the round time runs out, the robot does not reach the destination, the defending party wins.

In some embodiments, during a virtual battle, virtual characters of the attacking party and the defending party can both be revived. A revival area of the virtual character of the defending party is fixed. The revival area of the virtual character of the attacking party is in stages. In a battle process of the virtual battle, the revival area is divided into three stages (for example, the virtual battle takes three minutes, the virtual battle within the first minute is the first stage, the virtual battle within the second minute is the second stage, and the virtual battle within the third minute is the third stage), and a birth point (namely, the revival area) of the virtual character of the attacking is different in each stage.

For a rule of the robot 1202, a state of the robot 1202 determines an object and a manner of battle assistance of the robot 1202 for a virtual character in a virtual battle. In some embodiments, when there is a health point, if no attacking party is within a set range, the robot 1202 stands still; or if the attacking party is within the set range, the robot 1202 walks and moves toward the destination (namely, the first position), to help the attacking party win. During walking, if encountering a static object, the robot 1202 is blocked by a fixed-position skill with collision. That is, the robot 1202 cannot directly penetrate the static object, and automatically detours. If encountering a dynamic object (such as a virtual person or a virtual armor), the robot may forcibly knock away a movable virtual person, virtual armor, or the like.

In some embodiments, when the health point runs out, the robot 1202 is frozen, that is, loses a moving capability, thereby helping the defending party win. If not attacked within 10s, the robot 1202 enters automatic starting, that is, from freezing to starting. If in this case, the attacking party is within the set range, the robot 1202 accelerates starting, that is, time from freezing to starting is shorter than duration of starting.

In conclusion, specific actions of the robot are presented as follows:
automatic starting of the robot after freezing: freezing→automatic starting;
after the robot freezes, when the attacking party is nearby, freezing→accelerating starting;
when the attacking party is nearby in the starting state of the robot: standing →walking;
when there is no attacking party nearby in the starting state of the robot: the robot stops walking; and
when the defending party attacks the robot to freezing, starting→freezing.

(1) The robot has no invincible time during switching to the starting state. In other words, during activation of the robot, the health point keeps increasing. The health point is increased to a preset value, and then a starting action is displayed, indicating successful starting. If the robot is attacked during the activation, the health point decreases. (2) In some embodiments, if the robot is attacked to the freezing state in an instant when the robot is successfully started, and in this case, if the displaying of the starting action has not been completed, playing of the starting action is ended, and a freezing action is directly played. If the robot is attacked to the freezing state in a walking process, playing of a walking action is ended, and the freezing action is directly played.

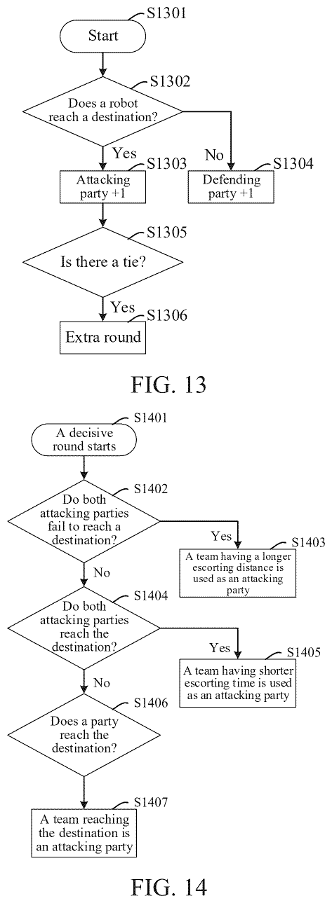

Exemplarily, FIG. 13 is an overall flowchart of an attack-defense mode game. As shown in FIG. 13, a process includes the following operations.

S1301: Start.

Exemplarily, a game battle in the attack-defense mode described in the foregoing embodiment is started. The game is a best-two-out-of-three game, and whether there is a third round is determined by points of two parties in the first two rounds. At the beginning of the first round, the server randomly selects one party as the attacking party, and the other party is the defending party. In the second round, the attacking party and the defending party are interchanged directly. In a single round, if the attacking party brings the robot to the destination, the attacking party wins; otherwise, the defending party wins.

S1302: Determine whether a robot reaches a destination.

Exemplarily, whether the robot reaches the destination is determined in a single round.

S1303: If the robot reaches the destination, the attacking party scores 1 point.

Exemplarily, if the robot reaches the destination in a single round, the attacking party in the round scores 1 point.

S1304: If the robot does not reach the destination, the defending party scores 1 point.

Exemplarily, if the robot does not reach the destination in a single round, the defending party in the round scores 1 point.

S1305: Determine whether there is a tie.

Exemplarily, scores of the attacking party and the defending party are compared after two rounds.

S1306: If there is a tie, perform an extra round.

Exemplarily, if the scores are the same, the third round, that is, an extra round, is performed, and an attacking party needs to be first determined in the extra round.

Exemplarily, FIG. 14 is a flowchart of determining an attacking party in an extra round. As shown in FIG. 14, a process includes the following operations. S1401: Start a decisive round.

Exemplarily, the extra round in the third round (the decisive round), starts. The attacking party is a dominating party by default. Therefore, in the extra round in the third round, the attacking party is determined according to representation of the two parties in the previous two rounds.

S1402: Determine whether the attacking parties do not reach the destination.

Exemplarily, whether the attacking party in each of the first two rounds does not transport the robot to the destination is determined.

S1403: If neither of the attacking parties reaches the destination, a team having a longer escorting distance is used as the attacking party.

Exemplarily, if the attacking party in each round does not transport the robot to the destination, the attacking party having a longer escorting distance in the two rounds is used as the attacking party in the third round. That is, when the rounds end, the attacking party corresponding to a round with a shorter distance from the robot to the destination in the two rounds is used as the attacking party in the third round.

S1404: If not both the attacking parties fail to reach the destination, determine whether both the attacking parties reach the destination.

Exemplarily, if not both the attacking parties in the two rounds fail to transport the robot to the destination, whether both the attacking parties in the two rounds have teleported the robot to the destination is determined.

S1405: If both the attacking parties reach the destination, a team having shorter escorting time is used as the attacking party.

Exemplarily, if the attacking party in each round transports the robot to the destination, the attacking party having a shorter escorting time in the two rounds is used as the attacking party in the third round, that is, the attacking party corresponding to a round with a shorter time consumed by the robot to move to the destination in the two rounds is used as the attacking party in the third round.

S1406: If not both attackers reach the destination, determine whether one party reaches the destination.

Exemplarily, if not the attacking party in each round transports the robot to the destination, the attacking party corresponding to a round of the two rounds transports the robot to the destination is determined.

S1407: A team reaching the destination is the attacking party.

Exemplarily, the attacking party escorts the robot to the destination in the two rounds is used as the attacking party in the third round.

In some embodiments, if the attacking party in each round fails to transport the robot to the destination, and in the two rounds, distances between the robot and the destination are the same; or if the attacking party in each round transports the robot to the destination, and time consumed by the robot moving to the destination is the same in the two rounds, an attacking in a round is randomly selected as the attacking party in the third round.

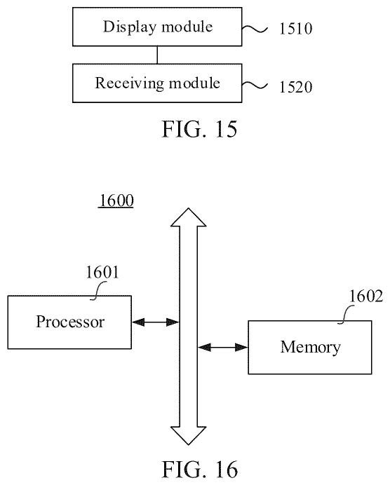

FIG. 15 is a structural block diagram of a virtual character battle apparatus according to an exemplary embodiment of this application. As shown in FIG. 15, the apparatus includes the following parts:

a display module 1510, configured to display a first virtual character and a second virtual character that have a confrontation relationship in a virtual scene, the virtual scene including a virtual support character, the virtual support character automatically moving toward a first position in the virtual scene, the first virtual character being configured for escorting the virtual support character, and the second virtual character being configured for hindering automatic movement of the virtual support character; and

a receiving module 1520, configured to display, in response to receiving a control operation performed on the first virtual character, interaction performed between the first virtual character and the virtual support character when the first virtual character escorts the virtual support character.

The display module 1510 is further configured to display a first battle result in response to the virtual support character moving to the first position, the first battle result being configured for indicating that the first virtual character wins a battle.

In some embodiments, the display module 1510 is further configured to: display, when the virtual support character satisfies a first assistance condition, a first assistance animation of the virtual support character providing battle assistance for the first virtual character; or display, when the virtual support character satisfies a second assistance condition, a second assistance animation of the virtual support character providing battle assistance for the second virtual character.

In some embodiments, the first assistance condition includes a first state condition, and the first state condition is a condition corresponding to an attribute value of the virtual support character; and the display module 1510 is further configured to:
display the virtual support character in a first character state when the attribute value of the virtual support character satisfies the first state condition, the virtual support character having a moving capability in the first character state; and
displaying the first assistance animation, the first assistance animation being an animation of the virtual support character in the first character state providing battle assistance for the first virtual character.

In some embodiments, the display module 1510 is further configured to display the virtual support character in the first character state in response to the attribute value of the virtual support character being greater than a preset attribute value.

In some embodiments, the display module 1510 is further configured to display a first movement animation as the first assistance animation when the first virtual character is within a preset character range of the virtual support character, the first movement animation being an animation of the virtual support character in the first character state moving toward the first position.

In some embodiments, the display module 1510 is further configured to display a character standing animation when the first virtual character is outside a preset character range of the virtual support character, the character standing animation being an animation of the virtual support character in the first character state standing in the virtual scene.

In some embodiments, the second assistance condition includes a second state condition, and the second state condition is a condition corresponding to an attribute value of the virtual support character; and the display module 1510 is further configured to:
display the virtual support character in a second character state when the attribute value of the virtual support character satisfies the second state condition; and
display the second assistance animation, the second assistance animation being an animation of the virtual support character in the second character state providing battle assistance for the second virtual character.

In some embodiments, the display module 1510 is further configured to display the virtual support character in the second character state in response to the attribute value of the virtual support character being less than or equal to a preset attribute value.

In some embodiments, the display module 1510 is further configured to display a character freezing animation, the character freezing animation being configured for indicating that the virtual support character loses a moving capability in the virtual scene; or display a second movement animation, the second movement animation being an animation of the virtual support character in the second character state moving in a direction away from the first position.

In some embodiments, the display module 1510 is further configured to:
display the virtual support character in a third character state and a first switching animation in response to duration for which the virtual support character is in the second character state reaching preset duration, the third character state being an intermediate character state in a process of switching from the second character state to the first character state, the first switching animation being configured for switching the virtual support character from the third character state to the first character state, and the first switching animation corresponding to first switching duration;
or
display, when the first virtual character is within a preset character range of the virtual support character, the virtual support character in the third character state and a second switching animation in response to duration for which the virtual support character is in the second character state reaching the preset duration, the second switching animation being configured for switching the virtual support character from the third character state to the first character state, and the second switching animation corresponding to second switching duration,
the first switching duration being greater than the second switching duration.

In some embodiments, the display module 1510 is further configured to:
display the virtual support character in a fourth character state in response to a number of times the virtual support character is switched to a character state reaching a preset number in a preset time period, the character state to which the virtual support character is switched including at least one of the first character state, the second character state, or the third character state; and
display a random event triggering animation, the random event triggering animation being configured for triggering random battle assistance in the virtual scene.

In some embodiments, the display module 1510 is further configured to display the first battle result in response to the virtual support character moving to the first position and a distance between the first position and a character destination position being less than or equal to a preset distance, the character destination position being a movement destination of the virtual support character preset in the virtual scene.

In some embodiments, the display module 1510 is further configured to display, when battle duration is less than preset battle duration, the first battle result in response to the virtual support character moving to the first position and a distance between the first position and a current position of the first virtual character being less than a distance between the first position and a current position of the second virtual character, the battle duration being duration of a battle between the first virtual character and the second virtual character.

In some embodiments, the first virtual character has a corresponding historical virtual battle, and the historical virtual battle has a corresponding historical battle result; the receiving module 1520 is configured to receive a battle start operation, the battle start operation being configured for starting a first virtual battle; and the display module 1510 is further configured to: in response to the battle start operation, display, when the historical battle result indicates that the first virtual character wins a battle, the first virtual character and the second virtual character that have the confrontation relationship in the virtual scene, a second position in the virtual scene including the virtual support character, and the first virtual character being within a preset character range corresponding to the second position.

In some embodiments, the display module 1510 is further configured to: in response to the battle start operation, display, when the historical battle result indicates that the first virtual character loses a battle, the first virtual character and the second virtual character that have the confrontation relationship in the virtual scene, a third position in the virtual scene including the virtual support character, and the first virtual character being outside a preset character range corresponding to the third position.

In some embodiments, the historical virtual battle has corresponding historical battle duration, and the historical battle duration is duration consumed by the first virtual character for winning a battle; and a fourth position in the virtual scene includes the virtual support character, and a distance between the fourth position and a current position of the first virtual character is positively correlated to the historical battle duration.

In conclusion, in the foregoing process, the battle result is determined according to whether the virtual support character with which the first virtual character interacts moves to the first position instead of completely depending on a fixed virtual object.

The virtual support character is used as a character movable in the virtual scene, so that utilization of the virtual support character is relatively high. In addition, the virtual support character has relatively high impact on the battle result, avoiding a problem that there are few game interaction forms in which a virtual character moves a fixed virtual object, increasing fun of a game, and improving utilization of computer resources.

The virtual character battle apparatus provided in the foregoing embodiments is illustrated with an example of division of the foregoing functional modules. In actual application, the functions may be allocated to and completed by different functional modules according to requirements, that is, the internal structure of the device is divided into different functional modules, to implement all or some of the functions described above. In addition, the virtual character battle apparatus provided in the foregoing embodiments and the virtual character battle method embodiments are based on the same concept. For details of a specific implementation process, refer to the method embodiments. Details are not described herein again.

FIG. 16 is a structural block diagram of an electronic device 1600 according to an exemplary embodiment of this application. The electronic device 1600 may be a portable mobile terminal, such as a smartphone, an in-vehicle terminal, a tablet computer, a moving picture experts group audio layer III (MP3) player, a moving picture experts group audio layer IV (MP4) player, a notebook computer, or a desktop computer. The electronic device 1600 may also be referred to as user equipment, a portable terminal, a laptop terminal, a desktop terminal, or the like. Generally, the electronic device 1600 includes: a processor 1601 and a memory 1602.

The processor 1601 may include one or more processing cores such as a 4-core processor or an 8-core processor. The processor 1601 may be implemented by using at least one hardware form of a digital signal processor (DSP), a field-programmable gate array (FPGA), or a programmable logic array (PLA).

The memory 1602 may include one or more computer-readable storage media, and the computer-readable storage medium may be non-transient. The memory 1602 may further include a high-speed random access memory and a nonvolatile memory, for example, one or more disk storage devices or flash storage devices.

In some embodiments, the electronic device 1600 further includes one or more sensors. The one or more sensors include, but are not limited to: a proximity sensor, a gyroscope sensor, and a pressure sensor.

In some embodiments, the electronic device 1600 further includes other components. A person skilled in the art may understand that the structure shown in FIG. 16 does not constitute a limitation on the electronic device 1600 and that the electronic device 1600 may include more or fewer components than those shown in the figure, a combination of some components, or different component arrangements.

An embodiment of this application further provides a computer device. The computer device can be implemented as the terminal or the server as shown in FIG. 2. The computer device includes a processor and a memory. The memory has at least one instruction, at least one segment of program, a code set, or an instruction set stored therein. The at least one instruction, the at least one segment of program, the code set, or the instruction set is loaded and executed by the processor to implement the virtual character battle method provided in the foregoing method embodiments.

An embodiment of this application further provides a computer-readable storage medium. The computer-readable storage medium has at least one instruction, at least one segment of a program, a code set, or an instruction set stored therein. The at least one instruction, the at least one segment of program, the code set, or the instruction set is loaded and executed by a processor to implement the virtual character battle method provided in the foregoing method embodiments.

An embodiment of this application further provides a computer program product or a computer program. The computer program product or the computer program includes computer instructions, and the computer instructions are stored in a computer-readable storage medium. A processor of a computer device reads the computer instructions from the computer-readable storage medium, and executes the computer instructions, to cause the computer device to perform the virtual character battle method according to any one of the foregoing embodiments.

What is claimed is:

1. A virtual character battle method performed by a computer device, the method comprising:
displaying a virtual scene including a first virtual character and a second virtual character that have a confrontation relationship and a virtual support character, and the second virtual character being configured for hindering automatic movement of the virtual support character in the virtual scene;
in response to receiving a control operation performed on the first virtual character by a user of the computer device, displaying interaction between the first virtual character and the virtual support character when the first virtual character escorts the virtual support character; and
in response to the virtual support character moving to a first position in the virtual scene, displaying a first battle result configured for indicating that the first virtual character wins a battle.

2. The method according to claim 1, further comprising:
when the virtual support character satisfies a first assistance condition, displaying a first assistance animation of the virtual support character providing battle assistance for the first virtual character; and
when the virtual support character satisfies a second assistance condition, displaying a second assistance animation of the virtual support character providing battle assistance for the second virtual character.

3. The method according to claim 2, wherein the first assistance condition comprises a first state condition, and the first state condition is a condition corresponding to an attribute value of the virtual support character; and
the displaying the first assistance animation of the virtual support character providing battle assistance for the first virtual character comprises:
displaying the virtual support character in a first character state when the attribute value of the virtual support character satisfies the first state condition, the virtual support character having a moving capability in the first character state; and
displaying the first assistance animation, the first assistance animation being an animation of the virtual support character in the first character state providing battle assistance for the first virtual character.

4. The method according to claim 3, wherein the displaying the virtual support character in a first character state when the attribute value of the virtual support character satisfies the first state condition comprises:
displaying the virtual support character in the first character state in response to the attribute value of the virtual support character being greater than a preset attribute value.

5. The method according to claim 3, wherein the displaying the first assistance animation comprises:
displaying a first movement animation as the first assistance animation when the first virtual character is within a preset character range of the virtual support character, the first movement animation being an animation of the virtual support character in the first character state moving toward the first position.

6. The method according to claim 3, further comprising:
displaying a character standing animation when the first virtual character is outside a preset character range of the virtual support character, the character standing animation being an animation of the virtual support character in the first character state standing in the virtual scene.

7. The method according to claim 2, wherein the second assistance condition comprises a second state condition, and the second state condition is a condition corresponding to an attribute value of the virtual support character; and
the displaying a second assistance animation of the virtual support character providing battle assistance for the second virtual character comprises:
displaying the virtual support character in a second character state when the attribute value of the virtual support character satisfies the second state condition; and
displaying the second assistance animation, the second assistance animation being an animation of the virtual support character in the second character state providing battle assistance for the second virtual character.

8. The method according to claim 7, wherein the displaying the virtual support character in a second character state when the attribute value of the virtual support character satisfies the second state condition comprises:
displaying the virtual support character in the second character state in response to the attribute value of the virtual support character being less than or equal to a preset attribute value.

9. The method according to claim 7, wherein the displaying the second assistance animation comprises:
displaying a character freezing animation, the character freezing animation being configured for indicating that the virtual support character loses a moving capability in the virtual scene; and
displaying a second movement animation, the second movement animation being an animation of the virtual support character in the second character state moving in a direction away from the first position.

10. The method according to claim 1, wherein the displaying a first battle result configured for indicating that the first virtual character wins the battle comprises:
displaying the first battle result in response to the virtual support character moving to the first position and a distance between the first position and a character destination position being less than or equal to a preset distance, the character destination position being a movement destination of the virtual support character preset in the virtual scene.

11. The method according to claim 1, wherein the displaying a first battle result configured for indicating that the first virtual character wins a battle comprises:
displaying, when battle duration is less than preset battle duration, the first battle result in response to the virtual support character moving to the first position and a distance between the first position and a current position of the first virtual character being less than a distance between the first position and a current position of the second virtual character, the battle duration being duration of a battle between the first virtual character and the second virtual character.

12. The method according to claim 1, wherein the first virtual character has a corresponding historical virtual battle, and the historical virtual battle has a corresponding historical battle result; and
the displaying the virtual scene including a first virtual character and a second virtual character that have a confrontation relationship comprises:
receiving a battle start operation, the battle start operation being configured for starting a first virtual battle; and
in response to the battle start operation, displaying, when the historical battle result indicates that the first virtual character wins a battle, the first virtual character and the second virtual character that have the confrontation relationship in the virtual scene, a second position in the virtual scene comprising the virtual support character, and the first virtual character being within a preset character range corresponding to the second position.

13. A computer device, comprising a processor and a memory, the memory having at least one segment of program stored therein, and the at least one segment of program, when executed by the processor, causing the computer device to implement a virtual character battle method including:
displaying a virtual scene including a first virtual character and a second virtual character that have a confrontation relationship and a virtual support character, and the second virtual character being configured for hindering automatic movement of the virtual support character in the virtual scene;
in response to receiving a control operation performed on the first virtual character by a user of the computer device, displaying interaction between the first virtual character and the virtual support character when the first virtual character escorts the virtual support character; and
in response to the virtual support character moving to a first position in the virtual scene, displaying a first battle result configured for indicating that the first virtual character wins a battle.

14. The computer device according to claim 13, wherein the method further comprises:
when the virtual support character satisfies a first assistance condition, displaying a first assistance animation of the virtual support character providing battle assistance for the first virtual character; and
when the virtual support character satisfies a second assistance condition, displaying a second assistance animation of the virtual support character providing battle assistance for the second virtual character.

15. The computer device according to claim 14, wherein the first assistance condition comprises a first state condition, and the first state condition is a condition corresponding to an attribute value of the virtual support character; and
the displaying the first assistance animation of the virtual support character providing battle assistance for the first virtual character comprises:
displaying the virtual support character in a first character state when the attribute value of the virtual support character satisfies the first state condition, the virtual support character having a moving capability in the first character state; and
displaying the first assistance animation, the first assistance animation being an animation of the virtual support character in the first character state providing battle assistance for the first virtual character.

16. The computer device according to claim 14, wherein the second assistance condition comprises a second state condition, and the second state condition is a condition corresponding to an attribute value of the virtual support character; and
the displaying a second assistance animation of the virtual support character providing battle assistance for the second virtual character comprises:
displaying the virtual support character in a second character state when the attribute value of the virtual support character satisfies the second state condition; and
displaying the second assistance animation, the second assistance animation being an animation of the virtual support character in the second character state providing battle assistance for the second virtual character.

17. The computer device according to claim 13, wherein the displaying a first battle result configured for indicating that the first virtual character wins the battle comprises:
displaying the first battle result in response to the virtual support character moving to the first position and a distance between the first position and a character destination position being less than or equal to a preset distance, the character destination position being a movement destination of the virtual support character preset in the virtual scene.

18. The computer device according to claim 13, wherein the displaying a first battle result configured for indicating that the first virtual character wins a battle comprises:
displaying, when battle duration is less than preset battle duration, the first battle result in response to the virtual support character moving to the first position and a distance between the first position and a current position of the first virtual character being less than a distance between the first position and a current position of the second virtual character, the battle duration being duration of a battle between the first virtual character and the second virtual character.

19. The computer device according to claim 13, wherein the first virtual character has a corresponding historical virtual battle, and the historical virtual battle has a corresponding historical battle result; and
the displaying the virtual scene including a first virtual character and a second virtual character that have a confrontation relationship comprises:
receiving a battle start operation, the battle start operation being configured for starting a first virtual battle; and
in response to the battle start operation, displaying, when the historical battle result indicates that the first virtual character wins a battle, the first virtual character and the second virtual character that have the confrontation relationship in the virtual scene, a second position in the virtual scene comprising the virtual support character, and the first virtual character being within a preset character range corresponding to the second position.

20. A non-transitory computer-readable storage medium, having at least one segment of program stored therein, the at least one segment of program, when executed by a processor of a computer device, causing the computer device to implement a virtual character battle method including:
displaying a virtual scene including a first virtual character and a second virtual character that have a confrontation relationship and a virtual support character, and the second virtual character being configured for hindering automatic movement of the virtual support character in the virtual scene;
in response to receiving a control operation performed on the first virtual character by a user of the computer device, displaying interaction between the first virtual character and the virtual support character when the first virtual character escorts the virtual support character; and
in response to the virtual support character moving to a first position in the virtual scene, displaying a first battle result configured for indicating that the first virtual character wins a battle.
